(19) United States
(12) Patent Application Publication
(10) Pub. No.: US 2013/0196948 A1
(43) Pub. Date: Aug. 1, 2013

(54) POLYMERS FOR BIOMATERIALS AND THERAPEUTICS

(71) Applicants: Omar Fisher, Cambridge, MA (US); Christopher G. Levins, Flemington, NJ (US); Robert S. Langer, Newton, MA (US); Daniel Griffith Anderson, Sudbury, MA (US)

(72) Inventors: Omar Fisher, Cambridge, MA (US); Christopher G. Levins, Flemington, NJ (US); Robert S. Langer, Newton, MA (US); Daniel Griffith Anderson, Sudbury, MA (US)

(73) Assignee: MASSACHUSETTS INSITUTE OF TECHNOLOGY, CAMBRIDGE, MA (US)

(21) Appl. No.: 13/806,240

(22) PCT Filed: Jun. 23, 2011
(86) PCT No.: PCT/US11/41644

§ 371 Date: Apr. 15, 2013

Related U.S. Application Data
(60) Provisional application No. 61/358,868, filed on Jun. 25, 2010.

(51) Int. Cl. C08B 37/02; C08B 37/16

(52) U.S. Cl. CPC C08B 37/0021; C08B 37/0012
USPC 514/58; 536/103; 536/112; 514/59

(57) ABSTRACT

Described herein are inventive compositions and methods relating to polymer conjugates and, in particular, to polymer conjugates having pendant side groups comprising ring moieties. In one aspect, embodiments are generally related to compositions that mimic naturally-occurring polyphenol compounds. The compositions comprise, in some embodiments, a polymer backbone having a plurality of hydroxyaromatic pendant side groups or derivatives thereof. For example, in some cases, a pendant side group may be a phenol or a substituted derivative thereof. In some cases, the pendant side group may be an oxidized hydroxyaromatic group, such as a quinone. In some embodiments, self-assembled structures comprising one or more of the polymer conjugates are provided. For example, the polymer conjugates may be combined with a complexing agent to form a particle. In some cases, a polymer conjugate may form a hydrogel. In some embodiments, the self-assembled structures may contain an agent, such as a pharmaceutically active agent. Also provided are methods and kits for forming the compositions, methods of using the compositions, and the like.

### RELATED APPLICATIONS

The present application claims priority to U.S. provisional application, U.S. Ser. No. 61/358,868, filed Jun. 25, 2010, entitled “POLYMERS FOR BIOMATERIALS AND THERAPEUTICS,” by Fisher et al., herein incorporated by reference.

### STATEMENT REGARDING FEDERALLY SPONSORED RESEARCH OR DEVELOPMENT

This invention was made with government support under Grant No. R37 EB000244, awarded by the NIH. The government has certain rights in this invention.

### FIELD OF INVENTION

Described herein are inventive compositions and methods relating to polymer conjugates and, in particular, to polymer conjugates having pendant side groups comprising ring moieties.

### BACKGROUND

Polyphenols are natural products comprising more than one phenol moiety per molecule. They are commonly produced by plants as secondary metabolites for purposes such as defense against predators, structural integrity, and protection from harmful solar radiation. Some polyphenols are useful, for example, for their medicinal antioxidant properties and their ability to affect specific biological processes. Polyphenols are also known to hydrogen bond with polymers such as PEG and PVP and are attractive as complexing agents because phenol groups typically form stronger hydrogen bonds than, for example, carboxyls, despite being weaker acids. Their relatively weak acidity makes them attractive for biomedical applications since their hydrogen bonding capabilities are generally preserved under physiological pH.

### SUMMARY OF THE INVENTION

Described herein are inventive compositions and methods relating to polymer conjugates and, in particular, to polymer conjugates having pendant side groups comprising ring moieties.

In one aspect, a composition is provided. The composition comprises a polysaccharide comprising a plurality of covalently bound pendant side groups, wherein each of the plurality of pendant side groups comprises a structure as in formula (II),

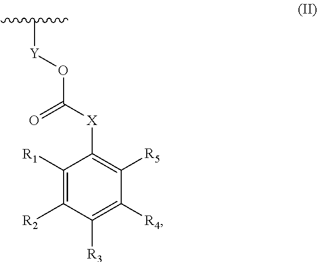

wherein “ [symbol] ” comprises a polymer, at least two of R₁, R₂, R₃, R₄, and R₅ is a hydroxyl group or a substituted derivative thereof and the remainder of R₁, R₂, R₃, R₄, and R₅ are each independently hydrogen or substituted, X and Y each comprise, independently, a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; or a salt thereof.

In another aspect, a composition is provided. The composition comprises a polymer comprising a plurality of covalently bound pendant side groups, wherein each of the plurality of pendant side groups comprises a structure as in formula (III),

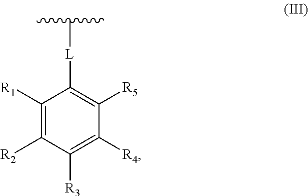

wherein, “ [symbol] ” comprises a polymer, at least one of R₁, R₂, R₃, R₄, and R₅ is a substituted hydroxyl group, the substituted hydroxyl group not being a methoxy group, and the remainder of R₁, R₂, R₃, R₄, and R₅ are each independently hydrogen or substituted, and L comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; and/or at least one covalent linkage group.

In another aspect, a composition is provided. The composition comprises a polymer comprising a plurality of covalently bound pendant side groups, wherein each of the plurality of pendant side groups comprises a structure selected from the group consisting of,

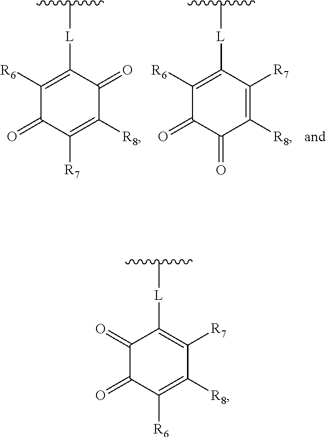

wherein, “ [symbol] ” comprises a polymer, R₆, R₇, and R₈ are each independently hydrogen or substituted, and L comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; and/or at least one covalent linkage group.

In another aspect, a composition is provided. The composition comprises a polymer comprising a plurality of pendant side groups, wherein each of the plurality of side groups comprises a quinone.

In another aspect, a composition is provided. The composition comprises a polymeric Lewis base and a self-assembled structure comprising a polymer having a plurality of covalently bound pendant side groups, wherein each of the plurality of pendant side groups comprises a structure as in formula (III),

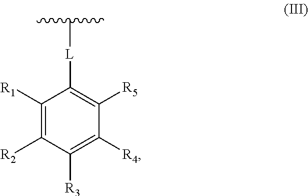

wherein, “ [symbol] ” comprises a polymer, at least one of R₁, R₂, R₃, R₄, and R₅ is a hydroxyl group or a substituted derivative thereof and the remainder of R₁, R₂, R₃, R₄, and R₅ are each independently hydrogen or substituted, and L comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; and/or at least one covalent linkage group; or a salt thereof.

In another aspect, a composition is provided. The composition comprises a hydrogel comprising a network of polymer chains, wherein at least some of the polymer chains are connected by crosslinks, wherein the crosslinks are formed from a reaction product of a phenolic pendant side group and a quinone pendant side group.

In another aspect, a composition is provided. The composition comprises a hydrogel comprising a network of polymers, wherein at least some of the polymers are crosslinked by at least one pendant side group comprising a structure as in formula (VI),

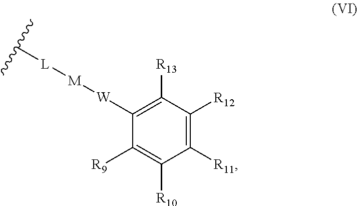

wherein, “ [symbol] ” comprises a polymer, L comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; and/or at least one covalent linkage group, M-W is a ring moiety, wherein M is a ring and W is a N, O, or S atom bonded to a carbon atom in the ring, at least one of R₉, R₁₀, R₁₁, R₁₂, and R₁₃ comprises a polymer, and the remainder of R₉, R₁₀, R₁₁, R₁₂, and R₁₃ are each independently hydrogen or substituted.

In another aspect, a kit is provided. The kit comprises a polymeric Lewis base; and a polymer having a plurality of covalently bound pendant side groups, wherein each of the plurality of pendant side groups comprises a structure as in formula (II):

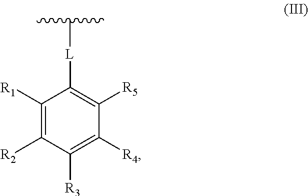

wherein, “ [symbol] ” comprises a polymer, at least one of R₁, R₂, R₃, R₄, and R₅ is a hydroxyl group or a substituted derivative thereof and the remainder of R₁, R₂, R₃, R₄, and R₅ are each independently hydrogen or substituted, and L comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; and/or at least one covalent linkage group; or a salt thereof.

In another aspect, a kit is provided. The kit comprises an oxidizing agent and a polymer having a plurality of covalently bound pendant side groups, wherein each of the plurality of pendant side groups comprises a structure as in formula (II),

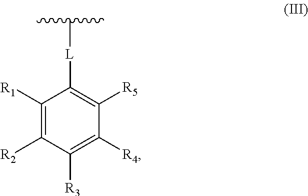

wherein, “ [symbol] ” comprises a polymer, at least one of R₁, R₂, R₃, R₄, and R₅ is a hydroxyl group or a substituted derivative thereof and the remainder of R₁, R₂, R₃, R₄, and R₅ are each independently hydrogen or substituted; or a salt thereof, and L comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; and/or at least one covalent linkage group; or a salt thereof.

In another aspect, a method is provided. The method comprises forming a hydrogel by combining a first polymer comprising a plurality of pendant side groups, wherein each of the plurality of side groups comprises a phenol, and a second polymer comprising a plurality of pendant side groups, wherein each of the plurality of side groups comprises a quinone.

In another aspect, a method is provided. The method comprises forming a particle by combining a polymer comprising a plurality of pendant side groups, wherein each of the plurality of side groups comprises a phenol, with a polymeric Lewis base.

In another aspect, a process for making a compound as in formula (H) above is provided. The process comprises reacting a polysaccharide with a protected phenol.

In another aspect a process for making a compound as in formula (III) above is provided. The process comprises reacting a polymer with a protected phenol.

In another aspect a process for making a compound of a structure selected from the group consisting of,

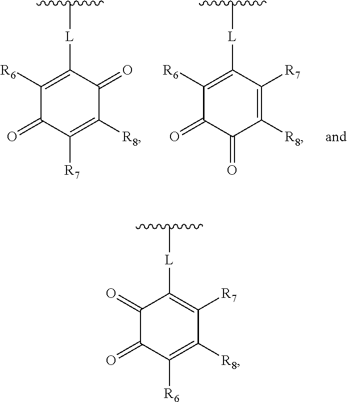

is provided. The process comprises combining an oxidizing agent with a polymer comprising a plurality of covalently bound pendant side groups, wherein each of the plurality of pendant side groups comprises a structure as in formula (III),

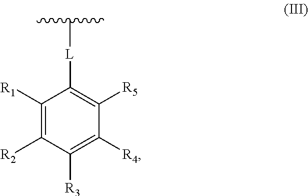

wherein, “ [symbol] ” comprises a polymer, at least one of R₁, R₂, R₃, R₄, and R₅ is a hydroxyl group, and the remainder of R₁, R₂, R₃, R₄, and R₅ are each independently hydrogen or substituted, and L comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; and/or at least one covalent linkage group; or a salt thereof.

In another aspect, a method for treating or preventing cancer is provided. The method comprises administering to a subject in need thereof, a polysaccharide comprising a plurality of covalently bound pendant side groups, wherein each of the plurality of pendant side groups comprises a structure as in formula (II):

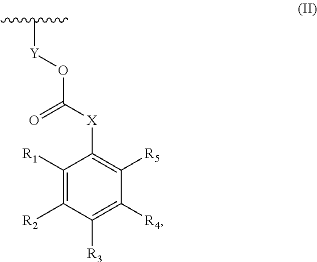

wherein, “ [symbol] ” comprises a polymer, at least two of R₁, R₂, R₃, R₄, and R₅ is a hydroxyl group or a substituted derivative thereof and the remainder of R₁, R₂, R₃, R₄, and R₅ are each independently hydrogen or substituted, X and Y are each, independently, a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; or a salt thereof; and a pharmaceutically acceptable carrier.

In another aspect, a method of treating or preventing a disease associated with oxidative stress is provided. The method comprises administering to a subject in need thereof, a polysaccharide comprising a plurality of covalently bound pendant side groups, wherein each of the plurality of pendant side groups comprises a structure as in formula (II):

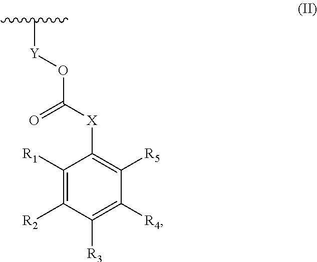

wherein, “ [symbol] ” comprises a polymer, at least two of R₁, R₂, R₃, R₄, and R₅ is a hydroxyl group or a substituted derivative thereof and the remainder of R₁, R₂, R₃, R₄, and R₅ are each independently hydrogen or substituted, X and Y are each, independently, a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; or a salt thereof; and a pharmaceutically acceptable carrier.

In another aspect, a composition is provided. The composition comprises a nanostructure and a polymer comprising a plurality of covalently bound pendant side groups, wherein each of the plurality of pendant side groups comprises a structure as in formula (III):

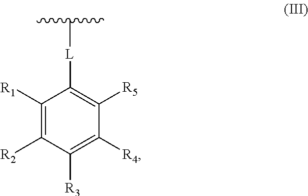

wherein, “ [symbol] ” comprises a polymer, at least one of R₁, R₂, R₃, R₄, and R₅ is a hydroxyl group, and the remainder of R₁, R₂, R₃, R₄, and R₅ are each independently hydrogen or substituted, L comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; and/or at least one covalent linkage group; or a salt thereof, wherein the polymer is associated with the nanostructure.

Other advantages and novel features of the present invention will become apparent from the following detailed description of various non-limiting embodiments of the invention when considered in conjunction with the accompanying figures. Unless otherwise noted, all references cited herein are incorporated by reference in their entirety. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows GPC traces for dextran-3,4,5-tris(benzyloxy)benzoic acid (TBBA) conjugates, according to certain embodiments. Each plot is labeled with the molecular weight of the dextran scaffold;

FIG. 2 shows plots of the average molecular weights of dextran-TBBA conjugates as a function of reaction volume (A), time (B), and catalyst concentration (C), according to certain embodiments. The scaffold molecular weight was 70 kDa. Each data point represents mean±standard deviation (n=3). The molecular weights were determined with polystyrene standards;

FIG. 3 shows absorbance spectra for dextran-TBBA conjugates deprotected in four different solvents, according to certain embodiments;

FIG. 4 shows ¹H NMR spectra for synthetic polygalloyls, according to certain embodiments. (A) Benzyloxy protecting groups have unique peaks near 5.0 ppm from the etheric hydrogens. (Top Inset) The chemical structure of TBBA with arrows showing the etheric hydrogens. (B) A water soluble polygallol deprotected with 10 wt % Pd/C for 24 h at 40° C. possesses residual benzyloxy groups. (C) The same polygallol deprotected with palladium black for 12 h at 40° C. is fully deprotected. (Bottom Inset) Soluble and insoluble pollygallols post-deprotection in carbonate buffer;

FIG. 5 shows photographs of Quebracho tannin/polyethylene glycol (QT/PEG) self-assembled colloids in phosphate-buffered saline (PBS), according to certain embodiments. The PEG molecular weights, from left to right are 750, 2000, 5000, and 10,000, according to certain embodiments. (A) Colloids immediately after preparation. (B) Colloids 24 hours after preparation. Visible browning occurs shortly after exposure to air and the colloidal disassembly occurs shortly thereafter;

FIG. 6 shows FTIR spectra for polyphenols synthesized from a dextran-70 k scaffold at a 1:1 COOH/OH ratio, according to certain embodiments;

FIG. 7 shows FTIR spectra for polycatechols (A) and polyresorcinols (B) synthesized from dextrans with molecular weights of 1,000 (i), 12,000 (ii) and 70,000 (iii), according to certain embodiments. All spectra are scaled to highest absorbance value;

FIG. 8 shows FTIR spectra for polycatechols using OH/COOH ratios of 1:1 (i), 2:1 (iii), and 3:1 (ii), according to certain embodiments;

FIGS. 9A-9D show turbidity plots for polycatechols as a function of PEG chain length, according to certain embodiments. Linear PEGs were mixed with polycatechols at mass ratios of 2.5:1 (circles), 5:1 (triangles), and 7.5:1 (squares). Polycatechols derived from α-cyclodextrin (FIG. 9A) and β-cyclodextrin (FIG. 9B) scaffolds showed maximum turbidity when mixed with PEGs≧5000 Da. At the two highest mass ratios the turbidity sharply decreases in mixtures with PEG<20,000 Da. The bottom two plots are for PEGs mixed with polycatechols derived from linear dextran scaffolds (MW=1000) esterified at a 1:1 (FIG. 9C) and 3:1 (FIG. 9D) hydroxyl to carboxyl ratio;

FIGS. 10A-10D show turbidity plots on complexes between polymer conjugates and star-shaped PEGs in PBS, according to certain embodiments. (FIGS. 10A-10C) Polycatechols derived from α-cyclodextrin (FIG. 10A), β-cyclodextrin (FIG. 10B), and dextran-1000 (FIG. 10C) mixed with 10 kDA 4-Arm PEGs with terminal hydroxyl, thiol, carboxyl, or primary amine groups. Legends show the PEG/polyphenol mass ratio. (FIG. 10D) Polycomplexes between cyclodextrin based polycatechols and star-shaped PEGs with terminal carboxyl groups. Each data point represents the mean±standard deviation (n=3);

FIG. 11 shows a photograph of various β-cyclocatechol mixtures, according to certain embodiments. From left to right: β-cyclocatechol in PBS at 250 μg/mL alone, mixed with PEG 20 kDa, PEG 100 kDa, and poly[oligo(ethylene glycol)methacrylate] (POEGMA). PEGs and POEGMA were used at 5× mass ratio to the polyphenol; and

FIG. 12 show plots of cell viability as a function of various compositions comprising polymer conjugates, according to certain embodiments.

### DETAILED DESCRIPTION

Described herein are inventive compositions and methods relating to polymer conjugates and, in particular, to polymer conjugates having pendant side groups comprising ring moieties. In one aspect, embodiments are generally related to compositions that mimic naturally-occurring polyphenol compounds. The compositions comprise, in some embodiments, a polymer backbone having a plurality of hydroxyaromatic pendant side groups or derivatives thereof. For example, in some cases, a pendant side group may be a phenol or a substituted derivative thereof. In some cases, the pendant side group may be an oxidized hydroxyaromatic group, such as a quinone. In some embodiments, self-assembled structures comprising one or more of the polymer conjugates are provided. For example, the polymer conjugates may be combined with a complexing agent to form a particle. In some cases, a polymer conjugate may form a hydrogel. In some embodiments, the self-assembled structures may contain an agent, such as a pharmaceutically active agent. Also provided are methods and kits for forming the compositions, methods of using the compositions, and the like.

In certain embodiments, the polymer conjugates described herein provide synthetic alternatives to naturally-occurring polyphenols. In some embodiments, the polymer conjugates may advantageously provide greater antioxidant capacity than naturally-occurring polyphenols. Furthermore, the methods described herein can allow, in some embodiments, superior control over the physical and chemical properties of the polymer conjugates as compared to naturally-occurring polyphenols.

Polymers are generally extended molecular structures comprising backbones which optionally contain pendant side groups. As used herein, “backbone” is given its ordinary meaning as used in the art, e.g., a linear chain of atoms within the polymer molecule by which other chains may be regarded as being pendant. Typically, but not always, the backbone is the longest chain of atoms within the polymer. A polymer may be a co-polymer, for example, a block, alternating, or random co-polymer. A polymer may also comprise a mixture of polymers. In some embodiments, the polymer may be acyclic or cyclic. A polymer may be crosslinked, for example through covalent bonds, ionic bonds, hydrophobic bonds, and/or metal binding. A polymer may be obtained from natural sources or be created synthetically.

Naturally-occurring polyphenols may be characterized as having a plurality of phenol moieties bonded to each other and/or to a core molecule. As such, naturally-occurring polyphenols may be distinguished from certain synthetic polymer conjugates described herein by their lack of a polymer backbone to which phenol moieties are attached as pendant side groups.

An exemplary, non-limiting list of polymers that are potentially suitable as backbones include polysaccharides; polynucleotides; polypeptides; peptide nucleic acids; polyurethane; polyamides; polycarbonates; polyanhydrides; polydioxanone; polyacetylenes and polydiacetylenes; polyphosphazenes; polysiloxanes; polyolefins; polyamines; polyesters; polyethers; poly(ether ketones); poly(alkaline oxides); poly(ethylene terephthalate); poly(methyl methacrylate); polystyrene; poly(lactic acid)/polylactide; poly(glycolic acid); poly(lactic-co-glycolic acid); poly(caprolactone); polysaccharides such as starch; poly(orthoesters); poly(anhydrides); poly(ether esters) such as polydioxanone; poly(carbonates); poly(amino carbonates); and poly(hydroxyalkanoates) such as poly(3-hydroxybutyrate) and poly(3-hydroxybutyrate-co-3-hydroxyvalerate) and derivatives and block, random, radial, linear, or teleblock copolymers, cross-linkable materials such as proteinaceous materials and/or blends of the above. Also suitable are polymers formed from monomeric alkylacrylates, alkylmethacrylates, alpha-methylstyrene, vinyl chloride and other halogen-containing monomers, maleic anhydride, acrylic acid, acrylonitrile, and the like. Monomers can be used alone, or mixtures of different monomers can be used to form homopolymers and copolymers. The particular polymer, copolymer, blend, or gel can be selected by those of ordinary skill in the art using readily available information and routine testing and experimentation so as to tailor a particular material for any of a wide variety of potential applications. Other potentially suitable polymers are described in the Polymer Handbook, Fourth Ed. Brandrup, J. Immergut, E. H., Grulke, E. A., Eds., Wiley-Interscience: 2003, each of which is incorporated herein by reference in its entirety. In some embodiments, a polymer may be biodegradable. In other embodiments, a polymer may be nondegradable.

In some embodiments, a polymer may be a polysaccharide. The polysaccharide may comprise any suitable carbohydrate or mixture of carbohydrates. As used herein, a “carbohydrate” (or, equivalently, a “sugar”) is a saccharide (including monosaccharides, oligosaccharides and polysaccharides) and/or a molecule (including oligomers or polymers) derived from one or more monosaccharides, e.g., by reduction of carbonyl groups, by oxidation of one or more terminal groups to carboxylic acids, by replacement of one or more hydroxy group(s) by a hydrogen atom, an amino group, a thiol group or similar heteroatomic groups, etc. The term “carbohydrate” also includes derivatives of these compounds. Non-limiting examples of carbohydrates include allose (“All”), altrose (“Alt”), arabinose (“Ara”), erythrose, erythrulose, fructose (“Fru”), fucosamine (“FucN”), fucose (“Fuc”), galactosamine (“GalN”), galactose (“Gal”), glucosamine (“GlcN”), glucosaminitol (“GlcN-ol”), glucose (“Glc”), glyceraldehyde, 2,3-dihydroxypropanal, glycerol (“Gro”), propane-1,2,3-triol, glycerone (“1,3-dihydroxyacetone”), 1,3-dihydroxypropanone, gulose (“Gul”), idose (“Ido”), lyxose (“Lyx”), mannosamine (“ManN”), mannose (“Man”), psicose (“Psi”), quinovose (“Qui”), quinovosamine, rhamnitol (“Rha-ol”), rhamnosamine (“RhaN”), rhamnose (“Rha”), ribose (“Rib”), ribulose (“Rul”), sorbose (“Sor”), tagatose (“Tag”), talose (“Tal”), tartaric acid, erythraric/threaric acid, threose, xylose (“Xyl”), or xylulose (“Xul”). In some cases, the carbohydrate may be a pentose (i.e., having 5 carbons) or a hexose (i.e., having 6 carbons); and in certain instances, the carbohydrate may be an oligosaccharide comprising pentose and/or hexose units, e.g., including those described above. A “monosaccharide,” is a carbohydrate or carbohydrate derivative that includes one saccharide unit. Similarly, a “disaccharide,” a “trisaccharide,” a “tetrasaccharide,” a “pentasaccharide,” etc. respectively has 2, 3, 4, 5, etc. saccharide units. A “polysaccharide,” as used herein, has at least 2 saccharide units, and the saccharide units may be joined in any suitable configuration, for example, through alpha or beta linkages, using any suitable hydroxy moiety, etc. The polysaccharide may be acyclic, cyclic, or branched in certain instances. In some embodiments, a polysaccharide may have at least 5 saccharide units, in certain embodiments at least 10 saccharide units, in certain embodiments at least 15 saccharide units, in certain embodiments at least 20 saccharide units, in certain embodiments at least 25 saccharide units, in certain embodiments at least 50 saccharide units, in certain embodiments at least 75 saccharide units, in certain embodiments at least 100 saccharide units, etc. In some cases, the carbohydrate is multimeric, i.e., comprising more than one saccharide chain. Nonlimiting examples of polysaccharides include cyclodextrin, dextran, hyaluronic acid, chitosan, chitin, alginate, agarose, and cellulose.

The polymer may have any suitable molecular weight. For example, in some embodiments, the polymer may have an average molecular weight greater than 1000 Da, in certain embodiments greater than 5000 Da, in certain embodiments greater than 10000 Da, in certain embodiments greater than 20000 Da, in certain embodiments greater than 50000 Da, in certain embodiments greater than 100000 Da, in certain embodiments greater than 500000 Da, or in certain embodiments greater than 1000000 Da. In some embodiments, the polymer may have at least 5 subunits, in certain embodiments at least 10 subunits, in certain embodiments at least 20 subunits, in certain embodiments at least 30 subunits, in certain embodiments at least 50 subunits, in certain embodiments at least 100 subunits, in certain embodiments at least 500 subunits, in certain embodiments at least 1000 subunits, or in certain embodiments at least 5000 subunits.

As discussed above, in some embodiments, a polymer may comprise pendant side groups. In some cases, the pendant side groups may be covalently bonded (i.e., conjugated) to the polymer. In some embodiments, the fraction of polymer subunits having a pendant side group can be quantified as the degree of substitution of the polymer. “Degree of substitution,” as used herein, refers to the fraction of subunits in a polymer having a pendant side group in relation to the total number of subunits in the polymer. In some embodiments, a polymer may have a degree of substitution of greater than 1%, in certain embodiments greater than 2%, in certain embodiments greater than 5%, in certain embodiments greater than 10%, in certain embodiments greater than 15%, in certain embodiments greater than 20%, in certain embodiments greater than 25%, in certain embodiments greater than 30%, in certain embodiments greater than 35%, in certain embodiments greater than 40%, in certain embodiments greater than 45%, in certain embodiments greater than 50%, in certain embodiments greater than 55%, in certain embodiments greater than 60%, in certain embodiments greater than 65%, in certain embodiments greater than 70%, in certain embodiments greater than 75%, or in certain embodiments greater than 80%. In some embodiments, the degree of substitution may be between 1% and 80%, in certain embodiments between 10% and 80%, in certain embodiments between 20% and 80%, and in certain embodiments between 25% and 70%.

In some embodiments, a pendant side group may be conjugated to a polymer using, for example, a covalent linkage group such as a carbon-carbon bond, carboxylate ester, phosphate ester, thioester, anhydride, acetal, ketal, carbamate, acyloxyalkyl ether, imine, orthoester, ether, amide, urethane, etc. As discussed in more detail below, any suitable functional groups may be used to form a covalent linkage group for conjugating the pendant side group to the polymer. In some embodiments, a linker may be used to join a pendant side group to a polymer. For example, in some embodiments, a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl group may be used as a linker. In some embodiments, the linker may be connected to the pendant side group using any suitable functional group. In some embodiments, the linker may be connected to the polymer using any suitable covalent linkage group.

Generally, the pendant side groups of the polymer conjugates described herein comprise a ring moiety. As used herein, a “ring moiety” refers to an unsaturated ring where at least some of the atoms forming the ring are carbon atoms. In certain embodiments, one or more of the carbon atoms in the ring is bonded, directly or indirectly, to an oxygen, nitrogen, or sulfur atom. An unsaturated ring has at least one double or triple bond. In some embodiments, an unsaturated ring may be aromatic. For example, the ring moiety may comprise a hydroxyaromatic group, an aminoaromatic group, and/or a thioaromatic group. As used herein, “hydroxyaromatic” refers to an aromatic ring having a hydroxyl group bonded to one of the atoms in the ring, “aminoaromatic” refers to an aromatic ring having an amino group bonded directly or indirectly to one of the atoms in the ring, and “thioaromatic” refers to an aromatic ring having an thiol group bonded directly or indirectly to one of the atoms in the ring. Of course, the ring may also include any suitable substituent on one or more of the remaining atoms in the ring. In some embodiments, the substituent may contain a functional group (e.g., a group suitable for conjugating the ring moiety to a polymer). The functional group may be directly bonded to the ring or may be connected by a linker, as described in more detail below.

In some embodiments, the ring moiety may comprise a single ring or a plurality of rings. In some cases, a ring moiety comprising a plurality of rings may comprise two or more rings joined by single bonds (e.g., sigma bonds), two or more fused rings, or both fused rings and rings joined by single bonds. In some embodiments, a ring may be a 5-membered ring, a 6-membered ring, or a 7-membered ring. As discussed above, at least some of the atoms in the ring are carbon atoms. In some embodiments, at least one atom in the ring may be a heteroatom, such as nitrogen or sulfur. Examples of 6-membered rings include benzene, pyridine, pyrazine, pyrimidine, pyridazine, and substituted derivatives thereof. Examples of fused 6-membered rings include naphthalene, anthracene, quinoline, isoquinoline, quinoxaline, acridine, quinazoline, crinnoline, and substituted derivatives thereof. Examples of 5-membered rings include furan, pyrrole, thiophene, imidazole, pyrazole, oxazole, isoxazole, thiazole, and substituted derivatives thereof. Examples of fused 6-membered and 5-membered rings include benzofuran, isobenzofuran, indole, isoindole, benzothiophene, benzo[c]thiophene, benzimidazole, purine, indazole, benzoxazole, benzisoxazole, benzothiazole, and substituted derivatives thereof. As discussed above, one or more of the carbon atoms in these rings may be bonded to an oxygen atom, and it should be understood that in some cases, the ring may be oxidized such that one or more of the carbon atoms in the ring is bonded to an oxygen atom by a double bond. For example, the ring moiety may comprise a quinone.

In some embodiments, an oxygen atom, nitrogen atom, or sulfur atom bonded to a carbon atom in a ring moiety may also be bonded to a hydrogen atom (i.e., the oxygen atom may be part of a hydroxyl group, the nitrogen atom may be part of an amino group, and the sulfur atom may be part of a thiol group). In other embodiments, an oxygen atom, nitrogen atom, or sulfur atom bonded to a carbon atom in a ring moiety may be additionally bonded to a non-hydrogen atom forming a substituted derivative.

In some embodiments, the non-hydrogen atom may be a carbon atom (i.e., the oxygen atom may be part of an ether group, an ester group, a carbamate group, etc.). In some cases, the non-hydrogen atom may be part of a protecting group, which may be removed from the ring moiety. In some embodiments, substantially all of the oxygen, nitrogen, or sulfur atoms bonded to carbon atoms in the ring moieties may be part of hydroxyl groups, amino groups, or thiol groups, respectively. In some cases, substantially all of the oxygen, nitrogen, or sulfur atoms bonded to carbon atoms in the ring moieties may be bonded to a non-hydrogen atom (e.g., protected). In some cases, an oxygen atom may be double-bonded to a carbon in a ring moiety, such as in a quinone.

In another set of embodiments, the polymer conjugate may comprise a polymer having a plurality of covalently bound pendant side groups, wherein each of the plurality of pendant side groups comprises a structure as in formula (I),

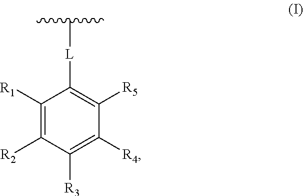

wherein “ [symbol] ” comprises a polymer, at least one of R₁, R₂, R₃, R₄, and R₅ may be a hydroxyl group, an amino group, a thiol group, or a substituted derivative thereof and the remainder of R₁, R₂, R₃, R₄, and R₅ may be each independently hydrogen or substituted, and L comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; and/or at least one covalent linkage group.

In some cases, at least two of R₁, R₂, R₃, R₄, and R₅ may be each, independently, a hydroxyl group, an amino group, a thiol group, or a substituted derivative thereof. In some embodiments, at least three of R₁, R₂, R₃, R₄, and R₅ may be each, independently, a hydroxyl group, an amino group, a thiol group, or a substituted derivative thereof. In some embodiments, R₂ and R₃, R₂ and R₄, or R₂, R₃, and R₄ are each, independently, a hydroxyl group, an amino group, a thiol group, or substituted derivative thereof. It should be understood that the pendant side groups of a polymer may have the same structure or may be a mixture of two or more different structures.

In some embodiments, the substituted derivative may be a protected hydroxyl group such as an ether, ester, or carbamate, a protected amino group such as an amide or carbamate, or a protected thiol group such as a thioether, thioester, or thiocarbamate. In one embodiment, the substituted derivative may be a benzyloxy group (i.e., a benzyl ether). In some embodiments, the substituted hydroxyl group is not a methoxy group (i.e., not a methyl ether). Other examples of protected hydroxyl, amino, and thiol groups are described in more detail below. In instances where, one or more of R₁, R₂, R₃, R₄, and R₅ is substituted, the substituent may be any suitable substituent. Non-limiting examples include a halide, a carboxyl, an amine, a nitrile, etc. Other examples are discussed elsewhere herein.

In some embodiments, the pendant side group may be conjugated to the polymer directly with a bond. In some embodiments, the pendant side group and the polymer may be connected by a linker moiety. The linker moiety may be, for example, a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl.

In some cases, the polymer conjugates described herein may be a free acid or may exist in a salt form. For example, one or more hydroxyl groups of the ring moieties may be deprotonated. The counterion of a deprotonated hydroxyl group (i.e., oxyanion) may be any suitable counterion.

In one set of embodiments, the polymer conjugate may comprise a polymer having a plurality of covalently bound pendant side groups, wherein each of the plurality of pendant side groups comprises a structure as in formula (II),

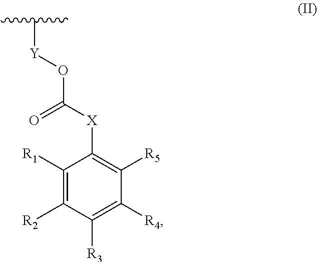

wherein “ [symbol] ” comprises a polymer and wherein at least one of R₁, R₂, R₃, R₄, and R₅ may be a hydroxyl group, an amino group, a thiol group, or a substituted derivative thereof, and the remainder of R₁, R₂, R₃, R₄, and R₅ may be each independently hydrogen or substituted. In some embodiments, X and Y each comprise, independently, a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl.

In some embodiments, X and Y may be each, independently, one or more methylene groups, one or more ethylene oxide groups, or one or more propylene oxide group.

In some embodiments, X and/or Y may be a linker moiety. For example, in some cases, a linker moiety may be used to introduce a new functional group to the polymer and/or ring moiety, e.g., to facilitate conjugation of the polymer to a ring moiety. For instance, a carboxyl functional group on the polymer or ring moiety may be reacted with a diol such that the polymer or ring moiety subsequently contains a free hydroxyl functional group. In another embodiment, the linker length may be chosen such that the polymer and ring moiety may be separated by a desired number of atoms.

In another embodiment, the polymer conjugate contains one or more of the following structures,

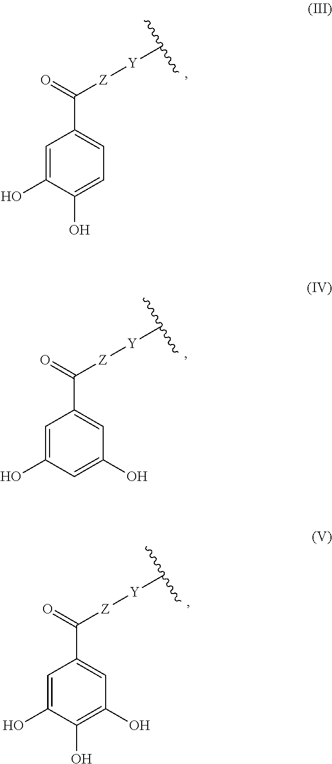

where “ [symbol] ” comprises a polymer, Z is N, O, or S, and Y comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl. Structure (III) is a catechol polymer conjugate, structure (IV) is a resorcinol polymer conjugate, and structure (V) is a gallol polymer conjugate.

In another set of embodiments, the polymer conjugate may comprise a polymer comprising a plurality of pendant side groups, wherein each of the plurality of side groups comprises a quinone. For example, in some embodiments, the polymer conjugate may comprise a polymer comprising a plurality of covalently bound pendant side groups, wherein each of the plurality of pendant side groups may comprise a structure selected from the group consisting of:

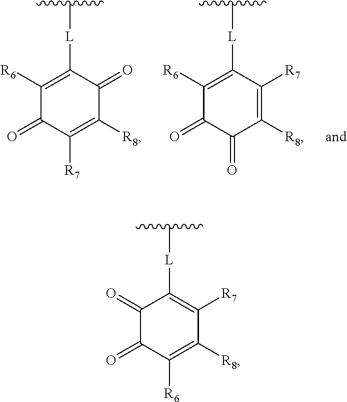

wherein R₆, R₇, and R₃ may be each independently hydrogen or substituted and where “ [symbol] ” comprises a polymer and L comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; and/or at least one covalent linkage group.

In certain embodiments, the polymer conjugates may be prepared by reacting a polymer with a ring moiety to form a polymer conjugate. Generally, the reaction occurs between a first functional group and a second functional group using suitable reaction conditions. Nonlimiting examples of functional groups include hydroxyl, active ester (e.g. N-hydroxysuccinimidyl ester or 1-benzotriazolyl ester), active carbonate (e.g. N-hydroxysuccinimidyl carbonate and 1-benzotriazolyl carbonate), acetal, aldehyde, aldehyde hydrate, alkenyl, acrylate, methacrylate, acrylamide, active sulfone, amine, hydrazide, thiol, carboxylic acid, isocyanate, isothiocyanate, maleimide, vinylsulfone, dithiopyridine, vinylpyridine, iodoacetamide, epoxide, glyoxal, dione, mesylate, tosylate, and mesylate. Other functional groups are described in Advanced Organic Chemistry: Part A: Structure and Mechanisms, Fifth Ed., and Advanced Organic Chemistry: Part B: Reaction and Synthesis, Fifth Ed., by Carey, F. A. and Sundberg, R. J. Springer: 2007. In some embodiments, a first functional group may be activated prior to reaction with the second functional group to facilitate reaction between the first functional group and the second functional group, as discussed in more detail below. In some embodiments, a second reaction may be performed after conjugating a polymer with a ring moiety, for example, to increase the stability of the bond formed between the polymer and the ring moiety. For instance, an aldehyde and an amine may be reacted to form an imine group to conjugate the polymer to the ring moiety. Since imine groups can be subject to hydrolysis, the imine group may be subsequently reduced using, for example, a reducing agent such as sodium borohydride, to form an amine.

In some embodiments, one or more reagents may be used to facilitate reaction between a first functional group and a second functional group. For example, in some cases a coupling reagent may be used. A coupling reagent can be used to activate a first functional group for reaction with a second functional group. Examples of coupling reagents include carbodiimides such as N,N-dicyclohexylcarbodiimide (DCC), N,N-diisopropylcarbodiimide (DIC), and 1-ethyl-3-(3-dimethylaminopropyl)-carbodiimide (EDC). For example, a carboxyl group may be activated using a carbodiimide reagent. Other suitable or potentially suitable coupling reagents and methods for using them are described in Protective Groups in Organic Synthesis, Third Ed. Greene, T. W. and Wuts, P. G., Eds., John Wiley & Sons, New York: 1999, and in the Encyclopedia of Reagents for Organic Synthesis, Second Ed. Paquette, L. A., Crich, D., Fuchs, P. L., and Molander, G., Eds., John Wiley & Sons, New York: 2009, each of which is incorporated herein by reference in its entirety.

In some embodiments, a catalyst may be used to increase the rate of reaction between a first functional group and a second functional group. For example, in some cases, the rate of reactions such as esterifications and amidations can be increased using a catalyst such as N,N-dimethylaminopyridine (DMAP).

In some embodiments, the rate of reaction can be increased by using a high concentration of polymer and/or ring moiety. For example, in some embodiments, the total concentration of the ring moiety may be at least 100 mM, at least 200 mM, at least 500 mM, at least 1M, or even higher.

In some embodiments, a solvent system may be chosen for performing the conjugation reaction that allows the starting materials and/or products to remain in solution, even at high concentration. In some embodiments, a variety of polar and non-polar solvents may be used. A wide variety of suitable or potentially suitable solvents are available commercially and exhaustive lists of solvents may be consulted in the prior art, for example, in the CRC Handbook of Chemistry and Physics, 91^{st} Ed. Haynes, W. M., Ed. CRC Press: 2010, the entire contents of which are incorporated herein by reference. In some cases, the solvent system may contain two or more solvents. In some embodiments, the solvent system may be organic. In some cases, an aqueous solvent system may be used. Non-limiting examples of suitable solvent systems include mixtures of dimethylsulfoxide and dichloromethane.

In some embodiments, a polymer and ring moiety may be reacted for period of time suitable for achieving a desired degree of substitution. For example, in some cases, the reaction may be carried out for at least 48 hours, at least 72 hours, or at least 96 hours.

In certain embodiments, a ring moiety and/or a polymer may have one or more functional groups that may be protected prior to conjugating the ring moiety and the polymer. For example, in some embodiments, the one or more hydroxyl groups of a ring moiety may be protected as described elsewhere herein. In some embodiments, protecting the hydroxyl groups and/or other groups prevents unwanted side reactions that can limit the degree of substitution. In some embodiments, the protecting groups may be removed subsequent to conjugation of the ring moiety and polymer using any suitable method. For example, the benzyl protecting group of a benzyl ether may be deprotected using a reagent such as palladium (e.g., palladium black or palladium on carbon) and H₂. Other protecting groups and deprotection methods may be used as well. Examples of protecting groups, methods for protecting, and methods for deprotecting are described in Protective Groups in Organic Synthesis, Third Ed. Greene, T. W. and Wuts, P. G., Eds., John Wiley & Sons, New York: 1999, and in the Encyclopedia of Reagents for Organic Synthesis, Second Ed. Paquette, L. A., Crich, D., Fuchs, P. L., and Molander, G., Eds., John Wiley & Sons, New York: 2009, each of which is incorporated herein by reference in its entirety.

The polymer conjugate may be purified by any suitable technique. For example, in some cases, the polymer conjugate may be purified by precipitation (e.g., using an acidic aqueous solution). In some embodiments, the precipitate may be collected by centrifugation. In some embodiments, the polymer conjugate may be purified using dialysis.

In some embodiments, a polymer conjugate may form a self-assembled complex, for example, with a complexing moiety. A complexing moiety may be any species capable of forming a complex with the polymer conjugate. In some embodiments, the complexing moiety may be a polymer. In some cases, the complexing moiety may be a polymeric Lewis base. A polymeric Lewis base is a polymer having electron donors that can donate electrons to a Lewis acid, such as a hydrogen atom. In some embodiments, the atom within a polymeric Lewis base that acts as an electron donor may be an oxygen atom in an oxidation state of 2, a sulfur atom in an oxidation state of 2, or a nitrogen atom in an oxidation state of 3. Non-limiting examples of polymeric Lewis bases include polyalkylene glycols such as polyethylene glycol and polypropylene glycol, polyvinylpyrrolidone, poly(N-isopropylacrylamide), and polyacrylamide. The polymeric Lewis base may comprise a single polymer or a mixture of polymers. In some embodiments, the polymer may be a copolymer, such as a block copolymer or graft copolymer. Without wishing to be bound by any theory, it is believed that a polymer conjugate forms a complex with a polymeric Lewis base by forming hydrogen bonds between hydroxyl groups of the pendant side groups of the polymer conjugate and the electron donors of the polymeric Lewis base. In some embodiments, the complexing moiety may be water soluble. For example, the complexing moiety may have a water solubility greater than 10 mg/L, in certain embodiments greater than 20 mg/L, in certain embodiments greater than 50 mg/L, in certain embodiments greater than 100 mg/L, in certain embodiments greater than 200 mg/L, in certain embodiments greater than 500 mg/L, in certain embodiments greater than 1 g/L, in certain embodiments greater than 2 g/L, in certain embodiments greater than 5 g/L, in certain embodiments greater than 10 g/L, in certain embodiments greater than 20 g/L, in certain embodiments greater than 50 g/L, in certain embodiments greater than 100 g/L, in certain embodiments greater than 200 g/L, or even greater.

The self-assembled complex may be, in some embodiments, in the form of a particle. In some embodiments, the particle may have a mean hydrodynamic diameter less than 10 microns, in certain embodiments less than 5 microns, in certain embodiments less than 1 micron, in certain embodiments less than 500 nanometers, in certain embodiments less than 200 nanometers, in certain embodiments less than 100 nanometers, and in certain embodiments less than 80 nanometers. In some cases the particle may have a mean hydrodynamic diameter between 20 nanometers and 100 nanometers, 50 nanometers and 200 nanometers, or 100 nanometers and 1 micron. In some embodiments, the molecular weight of the complexing agent and/or polymer conjugate may affect the size and/or stability of the particles. For example, in some embodiments, the stability of the complex may increase and/or the size of the particle may decrease as the molecular weight of the complexing agent and/or polymer conjugate increases. In some embodiments, the degree of substitution of the polymer conjugate may affect the size and/or stability of the particles. For example, in some cases, the size of the particles may decrease and/or the stability of the particles may increase as the degree of substitution of the polymer conjugate with respect to hydroxyl group-containing pendant side groups increases.

In some embodiments, a complex may be formed from a naturally-occurring polyphenol or a derivative thereof and a complexing agent. For example, a naturally-occurring polyphenol or a derivative thereof may be combined with a polymeric Lewis base to form a particle. In some embodiments, the naturally-occurring polyphenol may be a tannin.

In some embodiments, the complex may comprise an active agent. In some embodiments, the active agent may be a pharmaceutically active agent (i.e., a drug). A pharmaceutically active agent may be any bioactive agent. In some embodiments, the pharmaceutically active agent may be selected from “Approved Drug Products with Therapeutic Equivalence and Evaluations,” published by the United States Food and Drug Administration (F.D.A.) (the “Orange Book”). In some cases, the particle may be configured for controlled release of the active agent. For example, in some embodiments, the complex may degrade over time, thereby releasing the active agent in controlled fashion. In other embodiments, the complex may not be degradable, yet may still release the active agent in controlled fashion. In some embodiments, a particle comprising an active agent may be prepared by forming the complex in the presence of the active agent. For example, an active agent may be added to either or both a first solution containing the polymer conjugate and a second solution containing the complexing agent. The first solution and the second solution may then be mixed such that the self-assembled complex forms containing the active agent.

In some embodiments, a polymer conjugate may associate with a nanostructure. For example, in certain embodiments, the polymer conjugate may form a coating on a nanostructure. In some cases, the polymer conjugate may adsorb to the surface of the nanostructure randomly (i.e., where the polymer conjugate molecules are not aligned). In other embodiments, the polymer conjugate may adsorb to the nanostructure anisotropically. In certain embodiments, the polymer conjugate may wrap around a nanostructure. A nanostructure may be a nanotube (e.g., a carbon nanotube), a nanowire, a nanowhisker, etc. Generally, a nanostructure has a dimension less than 1 micron.

In some embodiments, the polymer conjugate may form a hydrogel. As used herein, “hydrogel” is given its ordinary meaning as used in the art, e.g., a network of polymer chains in an aqueous dispersion medium. In some embodiments, the hydrogel may be a self-assembled structure between a polymer conjugate and a complexing agent.

In some embodiments, a hydrogel may comprise a plurality of crosslinks, where each of the plurality of crosslinks may be formed from a reaction product of a nucleophilic group and an electrophilic group. For example, a hydroxyl group (e.g., a phenol group) of a pendant side group of a polymer conjugate may form a reaction product with a quinone pendant side group of a polymer conjugate. In some cases, the hydrogel is formed by crosslinking the polymer conjugate.

In one group of embodiments, a hydrogel may comprise a network of polymers, wherein at least some of the polymers are crosslinked by at least one pendant side group comprising a structure as in formula (VI):

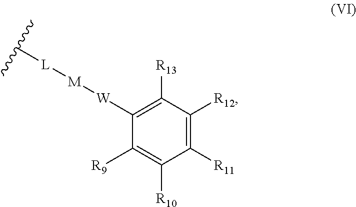

where “ [symbol] ” comprises a polymer, L comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; and/or at least one covalent linkage group, and M-W is a ring moiety where M is a ring and W is a N, O, or S atom bonded to a carbon atom in the ring, In some embodiments, at least one of R₉, R₁₀, R₁₁, R₁₂, and R₁₃ comprises a polymer, and the remainder of R₉, R₁₀, R₁₁, R₁₂, and R₁₃ are each independently hydrogen or substituted. It should be understood that “comprises a polymer” does not limit the pendant side group to being directly bonded to the polymer. Rather, the pendant side group and the polymer may be connected by any suitable linker and any suitable functional group, as described elsewhere herein. Thus, “comprises a polymer” can include, but is not limited to, any suitable linker and/or covalent linkage group disposed between the polymer and the pendant side group. For example, in some embodiments, the at least one of R₉, R₁₀, R₁₁, R₁₂, and R₁₃ comprising a polymer may further comprise a group L connecting the pendant side group to the polymer, where L is defined as above. In some embodiments, R₉, R₁₀, or R₁₃ may comprise a polymer. In some embodiments, a polymer conjugate may be crosslinked to the same or different polymer conjugate. In some embodiments, a crosslinker may be used to crosslink a polymer conjugate. For example, the crosslinker may be a star polymer such as a star-shaped polyethylene glycol having terminal functional groups capable of reacting with the pendant side groups of a polymer conjugate.

In some embodiments, a polymer conjugate hydrogel may be formed by reacting a first polymer conjugate comprising a plurality of nucleophilic pendant side groups with a second polymer conjugate comprising a plurality of electrophilic pendant side groups. In some embodiments, the first polymer conjugate and the second polymer conjugate may be isolated from each other initially and then mixed to allow spontaneous crosslinking and hydrogel formation to occur. In some instances, the second polymer conjugate may be formed in situ from a first polymer conjugate by exposing the first polymer conjugate to a suitable oxidizing agent. Non-limiting examples of suitable oxidizing agents include sodium periodate, ferrous salts (e.g., ferrous sulfate), potassium ferrocyanide, and chromic acid. It should be understood that in some cases, exposing a polymer conjugate comprising a plurality of phenolic pendant side group to a suitable oxidizing agent can result in the formation of polymer chains having a mixture of phenol groups and quinone groups within the same polymer chain. In some embodiments, the phenol groups and quinone groups may react to form crosslinks between two separate polymer chains and/or between at least two regions of the same polymer chain. It should also be understood that in some cases, exposing a polymer conjugate comprising a plurality of phenolic pendant side group to a suitable oxidizing agent can result in crosslinks that do not involve reaction with a quinone. For example, the crosslinks may be formed by a radical-mediated reaction.

In some embodiments, by controlling the amount of oxidizing agent mixed with a first polymer conjugate comprising a plurality of phenolic pendant side groups, a desired ratio of phenolic pendant side groups to quinone pendant side groups may be obtained. Alternatively, a measured amount of an isolated first polymer conjugate comprising a plurality of phenolic pendant side groups and a measured amount of an isolated second polymer conjugate comprising a plurality of quinone pendant side groups may be mixed to provide the desired ratio of phenolic pendant side groups to quinone pendant side groups. In other embodiments, a crosslinker comprising suitable electrophilic groups (e.g., Michael acceptors) may be combined with a polymer conjugate comprising a plurality of phenolic pendant side groups. In some embodiments, controlling the ratio of nucleophilic pendant side groups to electrophilic pendant side groups may be used to form a hydrogel having a desired crosslinking density.

In some embodiments, hydrogels formed from the polymer conjugates may be used to encapsulate an active agent or biological cells (e.g., human cells, cancer cells, mammalian cells, mouse cells, pig cells, primate cells, eukaryotic cells, prokaryotic cells, etc.). For example, the polymer conjugate may be mixed with an active agent or cells and then exposed to a suitable oxidizing agent to initiate crosslinking and hydrogel formation, thereby encapsulating the active agent and/or cells.

In some embodiments, an active agent may be attached to a polymer conjugate. For example, an active agent comprising a nucleophile may react with a quinone in a polymer conjugate to form a covalent bond between the active agent and the polymer conjugate. This may be advantageous, for example, for attaching an active agent, such as a growth factor or cell attachment molecule to a polymer conjugate without first modifying the active agent.

In some embodiments, the polymer conjugates described herein may be administered to a subject. The polymer conjugates and particles described herein may be used in “pharmaceutical compositions” or “pharmaceutically acceptable” compositions, which comprise a therapeutically effective amount of one or more of the polymers or particles described herein, formulated together with one or more pharmaceutically acceptable carriers, additives, and/or diluents. The pharmaceutical compositions described herein may be useful for diagnosing, preventing, treating or managing a disease or bodily condition including conditions characterized by oxidative stress or otherwise benefiting from administration of an antioxidant. Non-limiting examples of diseases or conditions characterized by oxidative stress or otherwise benefiting from administration of an antioxidant include cancer, cardiovascular disease, diabetes, arthritis, wound healing, chronic inflammation, and neurodegenerative diseases such as Alzheimer Disease.

The phrase “pharmaceutically acceptable” is employed herein to refer to those structures, materials, compositions, and/or dosage forms which are, within the scope of sound medical judgment, suitable for use in contact with the tissues of human beings and animals without excessive toxicity, irritation, allergic response, or other problem or complication, commensurate with a reasonable benefit/risk ratio.

The phrase “pharmaceutically-acceptable carrier” as used herein means a pharmaceutically-acceptable material, composition or vehicle, such as a liquid, gel or solid filler, diluent, excipient, or solvent encapsulating material, involved in carrying or transporting the subject compound, e.g., from a device or from one organ, or portion of the body, to another organ, or portion of the body. Each carrier must be “acceptable” in the sense of being compatible with the other ingredients of the formulation and not injurious to the patient. Some examples of materials which can serve as pharmaceutically-acceptable carriers include: sugars, such as lactose, glucose and sucrose; starches, such as corn starch and potato starch; cellulose, and its derivatives, such as sodium carboxymethyl cellulose, ethyl cellulose and cellulose acetate; powdered tragacanth; malt; gelatin; talc; excipients, such as cocoa butter and suppository waxes; oils, such as peanut oil, cottonseed oil, safflower oil, sesame oil, olive oil, corn oil and soybean oil; glycols, such as propylene glycol; polyols, such as glycerin, sorbitol, mannitol and polyethylene glycol; esters, such as ethyl oleate and ethyl laurate; agar; buffering agents, such as magnesium hydroxide and aluminum hydroxide; alginic acid; pyrogen-free water; isotonic saline; Ringer's solution; ethyl alcohol; pH buffered solutions; polyesters, polycarbonates and/or polyanhydrides; and other non-toxic compatible substances employed in pharmaceutical formulations.

As used herein, a “subject” or a “patient” refers to any mammal (e.g., a human), for example, a mammal that may be susceptible to a disease or bodily condition. Examples of subjects or patients include a human, a non-human primate, a cow, a horse, a pig, a sheep, a goat, a dog, a cat or a rodent such as a mouse, a rat, a hamster, or a guinea pig. Generally, the invention is directed toward use with humans. A subject may be a subject diagnosed with a certain disease or bodily condition or otherwise known to have a disease or bodily condition. In some embodiments, a subject may be diagnosed as, or known to be, at risk of developing a disease or bodily condition.

It will be appreciated that the compounds, as described herein, may be substituted with any number of substituents or functional moieties. In general, the term “substituted” whether preceded by the term “optionally” or not, and substituents contained in formulas of this invention, refer to the replacement of hydrogen radicals in a given structure with the radical of a specified substituent. When more than one position in any given structure may be substituted with more than one substituent selected from a specified group, the substituent may be either the same or different at every position. As used herein, the term “substituted” is contemplated to include all permissible substituents of organic compounds. In a broad aspect, the permissible substituents include acyclic and cyclic, branched and unbranched, carbocyclic and heterocyclic, aromatic and nonaromatic substituents of organic compounds. For purposes of this invention, heteroatoms such as nitrogen may have hydrogen substituents and/or any permissible substituents of organic compounds described herein which satisfy the valencies of the heteroatoms. Furthermore, the embodiment herein are not intended to be limited in any manner by the permissible substituents of organic compounds. Combinations of substituents and variables envisioned herein are preferably those that result in the formation of stable compounds. The term “stable”, as used herein, preferably refers to compounds which possess stability sufficient to allow manufacture and which maintain the integrity of the compound for a sufficient period of time to be detected and preferably for a sufficient period of time to be useful for the purposes detailed herein.

The term “aliphatic,” as used herein, includes both saturated and unsaturated, straight chain (i.e., unbranched), branched, acyclic, cyclic, or polycyclic aliphatic hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched and cyclic alkyl groups. An analogous convention applies to other generic terms such as “alkenyl,” “alkynyl,” and the like. Furthermore, as used herein, the terms “alkyl,” “alkenyl,” “alkynyl,” and the like encompass both substituted and unsubstituted groups. In certain embodiments, as used herein, “lower alkyl” is used to indicate those alkyl groups (cyclic, acyclic, substituted, unsubstituted, branched or unbranched) having 1-6 carbon atoms.

In certain embodiments, the alkyl, alkenyl, and alkynyl groups employed contain 1-30 aliphatic carbon atoms. In certain other embodiments, the alkyl, alkenyl, and alkynyl groups employed contain 1-10 aliphatic carbon atoms. In yet other embodiments, the alkyl, alkenyl, and alkynyl groups employed contain 1-8 aliphatic carbon atoms. In still other embodiments, the alkyl, alkenyl, and alkynyl groups employed contain 1-6 aliphatic carbon atoms. In yet other embodiments, the alkyl, alkenyl, and alkynyl groups employed contain 1-4 carbon atoms. Illustrative aliphatic groups thus include, but are not limited to, for example, methyl, ethyl, n-propyl, isopropyl, cyclopropyl, —CH₂-cyclopropyl, vinyl, allyl, n-butyl, sec-butyl, isobutyl, tertbutyl, cyclobutyl, —CH₂-cyclobutyl, n-pentyl, sec-pentyl, isopentyl, tert-pentyl, cyclopentyl, —CH₂-cyclopentyl, n-hexyl, sec-hexyl, cyclohexyl, —CH₂-cyclohexyl moieties and the like, which again, may bear one or more substituents. Alkenyl groups include, but are not limited to, for example, ethenyl, propenyl, butenyl, 1-methyl-2-buten-1-yl, and the like. Representative alkynyl groups include, but are not limited to, ethynyl, 2-propynyl (propargyl), 1-propynyl, and the like.

The term “alkyl” as used herein refers to saturated, straight- or branched-chain hydrocarbon radicals derived from a hydrocarbon moiety containing between one and twenty carbon atoms by removal of a single hydrogen atom. Examples of alkyl radicals include, but are not limited to, methyl, ethyl, propyl, isopropyl, n-butyl, tert-butyl, n-pentyl, neopentyl, n-hexyl, n-heptyl, n-octyl, n-decyl, n-undecyl, and dodecyl.

The term “alkenyl” denotes a monovalent group derived from a hydrocarbon moiety having at least one carbon-carbon double bond by the removal of a single hydrogen atom. Alkenyl groups include, for example, ethenyl, propenyl, butenyl, 1-methyl-2-buten-1-yl, and the like.

The term “alkynyl” as used herein refers to a monovalent group derived form a hydrocarbon having at least one carbon-carbon triple bond by the removal of a single hydrogen atom. Representative alkynyl groups include ethynyl, 2-propynyl (propargyl), 1-propynyl, and the like.

The term “alkoxy” or “thioalkyl” as used herein refers to an alkyl group, as previously defined, attached to the parent molecule through an oxygen atom or through a sulfur atom. In certain embodiments, the alkyl, alkenyl, and alkynyl groups contain 1-30 alipahtic carbon atoms. In certain other embodiments, the alkyl, alkenyl, and alkynyl groups contain 1-10 aliphatic carbon atoms. In yet other embodiments, the alkyl, alkenyl, and alkynyl groups employed in the invention contain 1-8 aliphatic carbon atoms. In still other embodiments, the alkyl, alkenyl, and alkynyl groups contain 1-6 aliphatic carbon atoms. In yet other embodiments, the alkyl, alkenyl, and alkynyl groups contain 1-4 aliphatic carbon atoms. Examples of alkoxy, include but are not limited to, methoxy, ethoxy, propoxy, isopropoxy, n-butoxy, tert-butoxy, neopentoxy, and n-hexoxy. Examples of thioalkyl include, but are not limited to, methylthio, ethylthio, propylthio, isopropylthio, n-butylthio, and the like.

The term “alkylamino” refers to a group having the structure —NHR′, wherein R′ is aliphatic, as defined herein. In certain embodiments, the aliphatic group contains 1-30 aliphatic carbon atoms. In certain other embodiments, the aliphatic group contains 1-10 aliphatic carbon atoms. In yet other embodiments, the aliphatic group employed in the invention contain 1-8 aliphatic carbon atoms. In still other embodiments, the aliphatic group contains 1-6 aliphatic carbon atoms. In yet other embodiments, the aliphatic group contains 1-4 aliphatic carbon atoms. Examples of alkylamino groups include, but are not limited to, methylamino, ethylamino, n-propylamino, iso-propylamino, cyclopropylamino, n-butylamino, tert-butylamino, neopentylamino, n-pentylamino, hexylamino, cyclohexylamino, and the like.

The term “carboxylic acid” as used herein refers to a group of formula —CO₂H. The term “dialkylamino” refers to a group having the structure —NRR′, wherein R and R′ are each an aliphatic group, as defined herein. R and R′ may be the same or different in an dialkyamino moiety. In certain embodiments, the aliphatic groups contains 1-30 aliphatic carbon atoms. In certain other embodiments, the aliphatic groups contains 1-10 aliphatic carbon atoms. In yet other embodiments, the aliphatic groups employed in the invention contain 1-8 aliphatic carbon atoms. In still other embodiments, the aliphatic groups contains 1-6 aliphatic carbon atoms. In yet other embodiments, the aliphatic groups contains 1-4 aliphatic carbon atoms. Examples of dialkylamino groups include, but are not limited to, dimethylamino, methyl ethylamino, diethylamino, methylpropylamino, di(n-propyl)amino, di(iso-propyl)amino, di(cyclopropyl)amino, di(n-butyl)amino, di(tert-butyl)amino, di(neopentyl)amino, di(n-pentyl)amino, di(hexyl)amino, di(cyclohexyl)amino, and the like. In certain embodiments, R and R′ are linked to form a cyclic structure. The resulting cyclic structure may be aromatic or non-aromatic. Examples of cyclic diaminoalkyl groups include, but are not limited to, aziridinyl, pyrrolidinyl, piperidinyl, morpholinyl, pyrrolyl, imidazolyl, 1,3,4-trianolyl, and tetrazolyl.

Some examples of substituents of the above-described aliphatic (and other) moieties of compounds of the invention include, but are not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; F; Cl; Br; I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

In general, the terms “aryl” and “heteroaryl,” as used herein, refer to stable mono- or polycyclic, heterocyclic, polycyclic, and polyheterocyclic unsaturated moieties having preferably 3-14 carbon atoms, each of which may be substituted or unsubstituted. Substituents include, but are not limited to, any of the previously mentioned substitutents, i.e., the substituents recited for aliphatic moieties, or for other moieties as disclosed herein, resulting in the formation of a stable compound. In certain embodiments of the present invention, “aryl” refers to a mono- or bicyclic carbocyclic ring system having one or two aromatic rings including, but not limited to, phenyl, naphthyl, tetrahydronaphthyl, indanyl, indenyl, and the like. In certain embodiments, the term “heteroaryl,” as used herein, refers to a cyclic aromatic radical having from five to ten ring atoms of which one ring atom is selected from S, O, and N; zero, one, or two ring atoms are additional heteroatoms independently selected from S, O, and N; and the remaining ring atoms are carbon, the radical being joined to the rest of the molecule via any of the ring atoms, such as, for example, pyridyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, isoquinolinyl, and the like.

It will be appreciated that aryl and heteroaryl groups can be unsubstituted or substituted, wherein substitution includes replacement of one, two, three, or more of the hydrogen atoms thereon independently with any one or more of the following moieties including, but not limited to: aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substitutents are illustrated by the specific embodiments shown in the Examples that are described herein.

The term “cycloalkyl,” as used herein, refers specifically to groups having three to seven, preferably three to ten carbon atoms. Suitable cycloalkyls include, but are not limited to cyclopropyl, cyclobutyl, cyclopentyl, cyclohexyl, cycloheptyl and the like, which, as in the case of other aliphatic, heteroaliphatic, or heterocyclic moieties, may optionally be substituted with substituents including, but not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

The term “heteroaliphatic,” as used herein, refers to aliphatic moieties that contain one or more oxygen, sulfur, nitrogen, phosphorus, or silicon atoms, e.g., in place of carbon atoms. Heteroaliphatic moieties may be branched, unbranched, cyclic or acyclic and include saturated and unsaturated heterocycles such as morpholino, pyrrolidinyl, etc. In certain embodiments, heteroaliphatic moieties are substituted by independent replacement of one or more of the hydrogen atoms thereon with one or more moieties including, but not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substitutents are illustrated by the specific embodiments shown in the Examples that are described herein.

The term “haloalkyl” denotes an alkyl group, as defined above, having one, two, or three halogen atoms attached thereto and is exemplified by such groups as chloromethyl, bromoethyl, trifluoromethyl, and the like.

The term “heterocycloalkyl” or “heterocycle,” as used herein, refers to a non-aromatic 5-, 6-, or 7-membered ring or a polycyclic group, including, but not limited to a bi- or tri-cyclic group comprising fused six-membered rings having between one and three heteroatoms independently selected from oxygen, sulfur and nitrogen, wherein (i) each 5-membered ring has 0 to 1 double bonds and each 6-membered ring has 0 to 2 double bonds, (ii) the nitrogen and sulfur heteroatoms may be optionally be oxidized, (iii) the nitrogen heteroatom may optionally be quaternized, and (iv) any of the above heterocyclic rings may be fused to a benzene ring. Representative heterocycles include, but are not limited to, pyrrolidinyl, pyrazolinyl, pyrazolidinyl, imidazolinyl, imidazolidinyl, piperidinyl, piperazinyl, oxazolidinyl, isoxazolidinyl, morpholinyl, thiazolidinyl, isothiazolidinyl, and tetrahydrofuryl. In certain embodiments, a “substituted heterocycloalkyl or heterocycle” group is utilized and as used herein, refers to a heterocycloalkyl or heterocycle group, as defined above, substituted by the independent replacement of one, two or three of the hydrogen atoms thereon with but are not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substitutents are illustrated by the specific embodiments shown in the Examples which are described herein.

The term “carbocycle,” as used herein, refers to an aromatic or non-aromatic ring in which each atom of the ring is a carbon atom.

The term “independently selected” is used herein to indicate that the R groups can be identical or different.

As used herein, the term “labeled” is intended to mean that a compound has at least one element, isotope, or chemical compound attached to enable the detection of the compound. In general, labels typically fall into three classes: a) isotopic labels, which may be radioactive or heavy isotopes, including, but not limited to, ²H, ³H, ³²P, ³⁵S, ⁶⁷Ga, ^{99m}Tc (Tc-99m), ¹¹¹In, ¹²³I, ¹²⁵I, ¹⁶⁹Yb and ¹⁸⁶Re; b) immune labels, which may be antibodies or antigens, which may be bound to enzymes (such as horseradish peroxidase) that produce detectable agents; and c) colored, luminescent, phosphorescent, or fluorescent dyes. It will be appreciated that the labels may be incorporated into the compound at any position that does not interfere with the biological activity or characteristic of the compound that is being detected. In certain embodiments of the invention, photoaffinity labeling is utilized for the direct elucidation of intermolecular interactions in biological systems. A variety of known photophores can be employed, most relying on photoconversion of diazo compounds, azides, or diazirines to nitrenes or carbenes (See, Bayley, H., Photogenerated Reagents in Biochemistry and Molecular Biology (1983), Elsevier, Amsterdam.), the entire contents of which are hereby incorporated by reference. In certain embodiments of the invention, the photoaffinity labels employed are o-, m- and p-azidobenzoyls, substituted with one or more halogen moieties, including, but not limited to 4-azido-2,3,5,6-tetrafluorobenzoic acid.

The terms “halo” and “halogen” as used herein refer to an atom selected from fluorine, chlorine, bromine, and iodine.

The term “heterocyclic,” as used herein, refers to a non-aromatic partially unsaturated or fully saturated 3- to 10-membered ring system, which includes single rings of 3 to 8 atoms in size and bi- and tri-cyclic ring systems which may include aromatic six-membered aryl or aromatic heterocyclic groups fused to a non-aromatic ring. These heterocyclic rings include those having from one to three heteroatoms independently selected from oxygen, sulfur, and nitrogen, in which the nitrogen and sulfur heteroatoms may optionally be oxidized and the nitrogen heteroatom may optionally be quaternized.

The term “heteroaryl,” as used herein, refers to a cyclic aromatic radical having from five to ten ring atoms of which one ring atom is selected from sulfur, oxygen, and nitrogen; zero, one, or two ring atoms are additional heteroatoms independently selected from sulfur, oxygen, and nitrogen; and the remaining ring atoms are carbon, the radical being joined to the rest of the molecule via any of the ring atoms, such as, for example, pyridyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, isoquinolinyl, and the like.

Specific heterocyclic and aromatic heterocyclic groups that may be included in the compounds include: 3-methyl-4-(3-methylphenyl)-piperazine, 3 methylpiperidine, 4-(bis-(4-fluorophenyl)methyl)-piperazine, 4-(diphenylmethyl)-piperazine, 4-(ethoxycarbonyl)-piperazine, 4-(ethoxycarbonylmethyl)-piperazine, 4-(phenylmethyl)-piperazine, 4-(1-phenylethyl)-piperazine, 4-(1,1-dimethylethoxycarbonyl)-piperazine, 4-(2-(bis-(2-propenyl)-amino)-ethyl)-piperazine, 4-(2-(diethylamino)-ethyl)-piperazine, 4-(2-chlorophenyl)-piperazine, 4-(2-cyanophenyl)-piperazine, 4-(2-ethoxyphenyl)-piperazine, 4-(2-ethylphenyl)-piperazine, 4-(2-fluorophenyl)-piperazine, 4-(2-hydroxyethyl)-piperazine, 4-(2-methoxyethyl)-piperazine, 4-(2-methoxyphenyl)-piperazine, 4-(2-methylphenyl)-piperazine, 4-(2-methylthiophenyl)-piperazine, 4-(2-nitrophenyl)-piperazine, 4-(2-nitrophenyl)-piperazine, 4-(2-phenylethyl)-piperazine, 4-(2-pyridyl)-piperazine, 4-(2-pyrimidinyl)-piperazine, 4-(2,3-dimethylphenyl)-piperazine, 4-(2,4-difluorophenyl)-piperazine, 4-(2,4-dimethoxyphenyl)-piperazine, 4-(2,4-dimethylphenyl)-piperazine, 4-(2,5-dimethylphenyl)-piperazine, 4-(2,6-dimethylphenyl)-piperazine, 4-(3-chlorophenyl)-piperazine, 4-(3-methylphenyl)-piperazine, 4-(3-trifluoromethylphenyl)-piperazine, 4-(3,4-dichlorophenyl)-piperazine, 4-3,4-dimethoxyphenyl)-piperazine, 4-(3,4-dimethylphenyl)-piperazine, 4-(3,4-methylenedioxyphenyl)-piperazine, 4-(3,4,5-trimethoxyphenyl)-piperazine, 4-(3,5-dichlorophenyl)-piperazine, 4-(3,5-dimethoxyphenyl)-piperazine, 4-(4-(phenylmethoxy)-phenyl)-piperazine, 4-(4-(3,1-dimethylethyl)-phenylmethyl)-piperazine, 4-(4-chloro-3-trifluoromethylphenyl)-piperazine, 4-(4-chlorophenyl)-3-methylpiperazine, 4-(4-chlorophenyl)-piperazine, 4-(4-chlorophenyl)-piperazine, 4-(4-chlorophenylmethyl)-piperazine, 4-(4-fluorophenyl)-piperazine, 4-(4-methoxyphenyl)-piperazine, 4-(4-methylphenyl)-piperazine, 4-(4-nitrophenyl)-piperazine, 4-(4-trifluoromethylphenyl)-piperazine, 4-cyclohexylpiperazine, 4-ethylpiperazine, 4-hydroxy-4-(4-chlorophenyl)-methylpiperidine, 4-hydroxy-4-phenylpiperidine, 4-hydroxypyrrolidine, 4-methylpiperazine, 4-phenylpiperazine, 4-piperidinylpiperazine, 4-(2-furanyl)carbonyl)piperazine, 4-((1,3-dioxolan-5-yl)-methyl)-piperazine, 6-fluoro-1,2,3,4-tetrahydro-2-methylquinoline, 1,4-diazacylcloheptane, 2,3-dihydroindolyl, 3,3-dimethylpiperidine, 4,4-ethylenedioxypiperidine, 1,2,3,4-tetrahydroisoquinoline, 1,2,3,4-tetrahydroquinoline, azacyclooctane, decahydroquinoline, piperazine, piperidine, pyrrolidine, thiomorpholine, and triazole.

One of ordinary skill in the art will appreciate that the synthetic methods, as described herein, may utilize a variety of protecting groups. By the term “protecting group,” as used herein, it is meant that a particular functional moiety, e.g., O, S, or N, is temporarily blocked so that a reaction can be carried out selectively at another reactive site in a multifunctional compound. In certain embodiments, a protecting group reacts selectively in good yield to give a protected substrate that is stable to the projected reactions; the protecting group should be selectively removable in good yield by readily available, preferably non-toxic reagents that do not attack the other functional groups; the protecting group forms an easily separable derivative (more preferably without the generation of new stereogenic centers); and the protecting group has a minimum of additional functionality to avoid further sites of reaction. As detailed herein, oxygen, sulfur, nitrogen, and carbon protecting groups may be utilized.

Hydroxyl protecting groups include methyl, methoxylmethyl (MOM), methylthiomethyl (MTM), t-butylthiomethyl, (phenyldimethylsilyl)-methoxymethyl (SMOM), benzyloxymethyl (BOM), p-methoxybenzyloxymethyl (PMBM), (4-methoxyphenoxy)methyl (p-AOM), guaiacolmethyl (GUM), t-butoxymethyl, 4-pentenyloxymethyl (POM), siloxymethyl, 2-methoxyethoxymethyl (MEM), 2,2,2-trichloroethoxymethyl, bis(2-chloroethoxy)methyl, 2-(trimethylsilyl)-ethoxymethyl (SEMOR), tetrahydropyranyl (THP), 3-bromotetrahydropyranyl, tetrahydrothiopyranyl, 1-methoxycyclohexyl, 4-methoxytetrahydropyranyl (MTHP), 4-methoxytetrahydrothiopyranyl, 4-methoxytetrahydrothiopyranyl-S,S-dioxide, 1-[(2-chloro-4-methyl)-phenyl]-4-methoxypiperidin-4-yl (CTMP), 1,4-dioxan-2-yl, tetrahydrofuranyl, tetrahydrothiofuranyl, 2,3,3a,4,5,6,7,7aoctahydro-7,8,8-trimethyl-4,7-methanobenzofuran-2-yl, 1-ethoxyethyl, 1-(2-chloroethoxy)ethyl, 1-methyl-1-methoxyethyl, 1-methyl-1-benzyloxyethyl, 1-methyl-1-benzyloxy-2-fluoroethyl, 2,2,2-trichloroethyl, 2-trimethylsilylethyl, 2-(phenylselenyl)ethyl, t-butyl, allyl, p-chlorophenyl, p-methoxyphenyl, 2,4-dinitrophenyl, benzyl, p-methoxybenzyl, 3,4-dimethoxybenzyl, o-nitrobenzyl, p-nitrobenzyl, p-halobenzyl, 2,6-dichlorobenzyl, p-cyanobenzyl, p-phenylbenzyl, 2-picolyl, 3-methyl-2-picolyl N-oxido, diphenylmethyl, p,p′-dinitrobenzhydryl, 5-dibenzosuberyl, triphenylmethyl, α-naphthyldiphenylmethyl, p-methoxyphenyldiphenylmethyl, di-(p-methoxyphenyl)-phenylmethyl, tri-(p-methoxyphenyl)-methyl, 4-(4′-bromophenacyloxyphenyl)-diphenylmethyl, 4,4′,4″-tris(4,5-dichlorophthalimidophenyl)-methyl, 4,4′,4″-tris-(levulinoyloxyphenyl)-methyl, 4,4′,4″-tris-(benzoyloxyphenyl)-methyl, 3-(imidazol-1-yl)bis(4′,4″-dimethoxyphenyl)methyl, 1,1-bis(4-methoxyphenyl)-1′-pyrenylmethyl, 9-anthryl, 9-(9-phenyl)-xanthenyl, 9-(9-phenyl-10-oxo)-anthryl, 1,3-benzodithiolan-2-yl, benzisothiazolyl S,S-dioxido, trimethylsilyl (TMS), triethylsilyl (TES), triisopropylsilyl (TIPS), dimethylisopropylsilyl (IPDMS), diethylisopropylsilyl (DEEPS), dimethylthexylsilyl, t-butyldimethylsilyl (TBDMS), t-butyldiphenylsilyl (TBDPS), tribenzylsilyl, tri-p-xylylsilyl, triphenylsilyl, diphenylmethylsilyl (DPMS), t-butylmethoxyphenylsilyl (TBMPS), formate, benzoylformate, acetate, chloroacetate, dichloroacetate, trichloroacetate, trifluoroacetate, methoxyacetate, triphenylmethoxyacetate, phenoxyacetate, p-chlorophenoxyacetate, 3-phenylpropionate, 4-oxopentanoate (levulinate), 4,4-(ethylenedithio)-pentanoate (levulinoyldithioacetal), pivaloate, adamantoate, crotonate, 4-methoxycrotonate, benzoate, p-phenylbenzoate, 2,4,6-trimethylbenzoate (mesitoate), alkyl methyl carbonate, 9-fluorenylmethyl carbonate (Fmoc), alkyl ethyl carbonate, alkyl 2,2,2-trichloroethyl carbonate (Troc), 2-(trimethylsilyl)ethyl carbonate (TMSEC), 2-(phenylsulfonyl)ethyl carbonate (Psec), 2-(triphenylphosphonio) ethyl carbonate (Peoc), alkyl isobutyl carbonate, alkyl vinyl carbonate alkyl allyl carbonate, alkyl p-nitrophenyl carbonate, alkyl benzyl carbonate, alkyl p-methoxybenzyl carbonate, alkyl 3,4-dimethoxybenzyl carbonate, alkyl o-nitrobenzyl carbonate, alkyl p-nitrobenzyl carbonate, alkyl S-benzyl thiocarbonate, 4-ethoxy-1-napththyl carbonate, methyl dithiocarbonate, 2-iodobenzoate, 4-azidobutyrate, 4-nitro-4-methylpentanoate, o-(dibromomethyl)-benzoate, 2-formylbenzenesulfonate, 2-(methylthiomethoxy)ethyl, 4-(methylthiomethoxy)butyrate, 2-(methylthiomethoxymethyl)benzoate, 2,6-dichloro-4-methylphenoxyacetate, 2,6-dichloro-4-(1,1,3,3-tetramethylbutyl)phenoxyacetate, 2,4-bis(1,1-dimethylpropyl)phenoxyacetate, chlorodiphenylacetate, isobutyrate, monosuccinoate, (E)-2-methyl-2-butenoate, o-(methoxycarbonyl)-benzoate, α-naphthoate, nitrate, alkyl N,N,N′,N′-tetramethylphosphorodiamidate, alkyl N-phenylcarbamate, borate, dimethylphosphinothioyl, alkyl 2,4-dinitrophenylsulfenate, sulfate, methanesulfonate (mesylate), benzylsulfonate, and tosylate (Ts).

For protecting 1,2- or 1,3-diols, the protecting groups include methylene acetal, ethylidene acetal, 1-t-butylethylidene ketal, 1-phenylethylidene ketal, (4-methoxyphenyl)ethylidene acetal, 2,2,2-trichloroethylidene acetal, acetonide, cyclopentylidene ketal, cyclohexylidene ketal, cycloheptylidene ketal, benzylidene acetal, p-methoxybenzylidene acetal, 2,4-dimethoxybenzylidene ketal, 3,4-dimethoxybenzylidene acetal, 2-nitrobenzylidene acetal, methoxymethylene acetal, ethoxymethylene acetal, dimethoxymethylene ortho ester, 1-methoxyethylidene ortho ester, 1-ethoxyethylidine ortho ester, 1,2-dimethoxyethylidene ortho ester, α-methoxybenzylidene ortho ester, 1-(N,N-dimethylamino)-ethylidene derivative, α-(N,N′-dimethylamino)-benzylidene derivative, 2-oxacyclopentylidene ortho ester, di-t-butylsilylene group (DTBS), 1,3-(1,1,3,3-tetraisopropyldisiloxanylidene) derivative (TIPDS), tetra-tbutoxydisiloxane-1,3-diylidene derivative (TBDS), cyclic carbonates, cyclic boronates, ethyl boronate, and phenyl boronate.

Amino-protecting groups include methyl carbamate, ethyl carbamante, 9-fluorenylmethyl carbamate (Fmoc), 9-(2-sulfo)-fluorenylmethyl carbamate, dibromo)-fluoroenylmethyl carbamate, 2,7-di-t-butyl-[9-(10,10-dioxo-10,10,10,10-tetrahydrothioxanthyl)]methyl carbamate (DBD-Tmoc), 4-methoxyphenacyl carbamate (Phenoc), 2,2,2-trichloroethyl carbamate (Troc), 2-trimethylsilylethyl carbamate (Teoc), 2-phenylethyl carbamate (hZ), 1-(1-adamantyl)-1-methylethyl carbamate (Adpoc), 1,1-dimethyl-2-haloethyl carbamate, 1,1-dimethyl-2,2-dibromoethyl carbamate (DB-t-BOC), 1,1-dimethyl-2,2,2-trichloroethyl carbamate (TCBOC), 1-methyl-1-(4-biphenyl)ethyl carbamate (Bpoc), 1-(3,5-dit-butylphenyl)-1-methylethyl carbamate (t-Bumeoc), 2-(2′- and 4′-pyridyl)ethyl carbamate (Pyoc), 2-(N,N-dicyclohexylcarboxamido)ethyl carbamate, t-butyl carbamate (BOC), 1-adamantyl carbamate (Adoc), vinyl carbamate (Voc), allyl carbamate (Alloc), 1-isopropylallyl carbamate (Ipaoc), cinnamyl carbamate (Coc), 4-nitrocinnamyl carbamate (Noc), 8-quinolyl carbamate, N-hydroxypiperidinyl carbamate, alkyldithiocarbamate, benzyl carbamate (Cbz), p-methoxybenzyl carbamate (Moz), p-nitobenzyl carbamate, p-bromobenzyl carbamate, p-chlorobenzyl carbamate, 2,4-dichlorobenzyl carbamate, 4-methylsulfinylbenzyl carbamate (Msz), 9-anthrylmethyl carbamate, diphenylmethyl carbamate, 2-methylthioethyl carbamate, 2-methylsulfonylethyl carbamate, 2-(p-toluenesulfonyl)ethyl carbamate, [2-(1,3-dithianyl]methyl carbamate (Dmoc), 4-methylthiophenyl carbamate (Mtpc), 2,4-dimethylthiophenyl carbamate (Bmpc), 2-phosphonioethyl carbamate (Peoc), 2-triphenylphosphonioisopropyl carbamate (Ppoc), 1,1-dimethyl-2-cyanoethyl carbamate, m-chloro-p-acyloxybenzyl carbamate, p-(dihydroxyboryl)benzyl carbamate, 5-benzisoxazolylmethyl carbamate, 2-(trifluoromethyl)-6-chromonylmethyl carbamate (Tcroc), m-nitrophenyl carbamate, 3,5-dimethoxybenzyl carbamate, o-nitrobenzyl carbamate, 3,4-dimethoxy-6-nitrobenzyl carbamate, phenyl(o-nitrophenyl)methyl carbamate, phenothiazinyl-(10)-carbonyl derivative, N′-p-toluenesulfonylaminocarbonyl derivative, N′-phenylaminothiocarbonyl derivative, t-amyl carbamate, S-benzyl thiocarbamate, p-cyanobenzyl carbamate, cyclobutyl carbamate, cyclohexyl carbamate, cyclopentyl carbamate, cyclopropylmethyl carbamate, p-decyloxybenzyl carbamate, 2,2-dimethoxycarbonylvinyl carbamate, o-(N,N-dimethylcarboxamido)benzyl carbamate, 1,1-dimethyl-3-(N,N-dimethylcarboxamido) propyl carbamate, 1,1-dimethylpropynyl carbamate, di-(2-pyridyl)methyl carbamate, 2-furanylmethyl carbamate, 2-iodoethyl carbamate, isoborynl carbamate, isobutyl carbamate, isonicotinyl carbamate, p-(p′-methoxyphenylazo)benzyl carbamate, 1-methylcyclobutyl carbamate, 1-methylcyclohexyl carbamate, 1-methyl-1-cyclopropylmethyl carbamate, 1-methyl-1-(3,5-dimethoxyphenyl)ethyl carbamate, 1-methyl-1-(p-phenylazophenyl)ethyl carbamate, 1-methyl-1-phenylethyl carbamate, 1-methyl-1-(4-pyridyl)ethyl carbamate, phenyl carbamate, p-(phenylazo)benzyl carbamate, 2,4,6-tri-t-butylphenyl carbamate, 4-(trimethylammonium)benzyl carbamate, 2,4,6-trimethylbenzyl carbamate, formamide, acetamide, chloroacetamide, trichloroacetamide, trifluoroacetamide, phenylacetamide, 3-phenylpropanamide, picolinamide, 3-pyridylcarboxamide, N-benzoylphenylalanyl derivative, benzamide, p-phenylbenzamide, o-nitophenylacetamide, o-nitrophenoxyacetamide, acetoacetamide, (N′-dithiobenzyloxycarbonylamino)acetamide, 3-(p-hydroxyphenyl) propanamide, 3-(o-nitrophenyl)propanamide, 2-methyl-2-(o-nitrophenoxy) propanamide, 2-methyl-2-(o-phenylazophenoxy)propanamide, 4-chlorobutanamide, 3-methyl-3-nitrobutanamide, o-nitrocinnamide, N-acetylmethionine derivative, o-nitrobenzamide, o-(benzoyloxymethyl)benzamide, 4,5-diphenyl-3-oxazolin-2-one, N-phthalimide, N-dithiasuccinimide (Dts), N-2,3-diphenylmaleimide, N-2,5-dimethylpyrrole, N-1,1,4,4-tetramethyldisilylazacyclopentane adduct (STABASE), 5-substituted 1,3-dimethyl-1,3,5-triazacyclohexan-2-one, 5-substituted 1,3-dibenzyl-1,3,5-triazacyclohexan-2-one, 1-substituted 3,5-dinitro-4-pyridone, N-methylamine, N-allylamine, N-[2-(trimethylsilyl)ethoxy]methylamine (SEM), N-3-acetoxypropylamine, N-(1-isopropyl-4-nitro-2-oxo-3-pyroolin-3-yl)amine, quaternary ammonium salts, N-benzylamine, N-di(4-methoxyphenyl)methylamine, N-5-dibenzosuberylamine, N-triphenylmethylamine (Tr), N-[(4-methoxyphenyl)diphenylmethyl]amine (MMTr), N-9-phenylfluorenylamine (PhF), N-2,7-dichloro-9-fluorenylmethyleneamine, N-ferrocenylmethylamino (Fcm), N-2-picolylamino N′-oxide, N-1,1-dimethylthiomethyleneamine, N-benzylideneamine, N-p-methoxybenzylideneamine, N-diphenylmethyleneamine, N-[(2-pyridyl)-mesityl]-methyleneamine, N—(N′,N′-dimethylaminomethylene)amine, N,N′-isopropylidenediamine, N-p-nitrobenzylideneamine, N-salicylideneamine, N-5-chlorosalicylideneamine, N-(5-chloro-2-hydroxyphenyl)-phenylmethyleneamine, N-cyclohexylideneamine, N-(5,5-dimethyl-3-oxo-1-cyclohexenyl)amine, N-borane derivative, N-diphenylborinic acid derivative, N-[phenyl-(pentacarbonylchromium- or tungsten)carbonyl]amine, N-copper chelate, N-zinc chelate, N-nitroamine, N-nitrosoamine, amine N-oxide, diphenylphosphinamide (Dpp), dimethylthiophosphinamide (Mpt), diphenylthiophosphinamide (Ppt), dialkyl phosphoramidates, dibenzyl phosphoramidate, diphenyl phosphoramidate, benzenesulfenamide, o-nitrobenzenesulfenamide (Nps), 2,4-dinitrobenzenesulfenamide, pentachlorobenzenesulfenamide, 2-nitro-4-methoxybenzenesulfenamide, triphenylmethylsulfenamide, 3-nitropyridinesulfenamide (Npys), p-toluenesulfonamide (Ts), benzenesulfonamide, 2,3,6,-trimethyl-4-methoxybenzenesulfonamide (Mtr), 2,4,6-trimethoxybenzenesulfonamide (Mtb), 2,6-dimethyl-4-methoxybenzenesulfonamide (Pme), 2,3,5,6-tetramethyl-4-methoxybenzenesulfonamide (Mte), 4-methoxybenzenesulfonamide (Mbs), 2,4,6-trimethylbenzenesulfonamide (Mts), 2,6-dimethoxy-4-methylbenzenesulfonamide (iMds), 2,2,5,7,8-pentamethylchroman-6-sulfonamide (Pmc), methanesulfonamide (Ms), f3-trimethylsilylethanesulfonamide (SES), 9-anthracenesulfonamide, 4-(4′,8′-dimethoxynaphthylmethyl)-benzenesulfonamide (DNMBS), benzylsulfonamide, trifluoromethylsulfonamide, and phenacylsulfonamide.

Exemplary protecting groups are detailed herein, however, it will be appreciated that the present invention is not intended to be limited to these protecting groups; rather, a variety of additional equivalent protecting groups can be readily identified using the above criteria and utilized in the method of the present invention. Additionally, a variety of protecting groups are described in Protective Groups in Organic Synthesis, Third Ed. Greene, T. W. and Wuts, P. G., Eds., John Wiley & Sons, New York: 1999, the entire contents of which are hereby incorporated by reference.

In one embodiment, a kit may be provided, containing one or more of the above compositions. A “kit,” as used herein, typically defines a package or an assembly including one or more of the compositions of the invention, and/or other compositions associated with the invention, for example, as previously described. Each of the compositions of the kit may be provided in liquid form (e.g., in solution), in solid form (e.g., a dried powder), etc. A kit of the invention may, in some cases, include instructions in any form that are provided in connection with the compositions of the invention in such a manner that one of ordinary skill in the art would recognize that the instructions are to be associated with the compositions of the invention. For instance, the instructions may include instructions for the use, modification, mixing, diluting, preserving, administering, assembly, storage, packaging, and/or preparation of the compositions and/or other compositions associated with the kit. The instructions may be provided in any form recognizable by one of ordinary skill in the art as a suitable vehicle for containing such instructions, for example, written or published, verbal, audible (e.g., telephonic), digital, optical, visual (e.g., videotape, DVD, etc.) or electronic communications (including Internet or web-based communications), provided in any manner.

The following examples are intended to illustrate certain embodiments of the present invention, but do not exemplify the full scope of the invention.

### Example 1

This example demonstrates synthesis of polymer conjugates according to the invention.

Polybenzyloxybenzoates were synthesized via esterification of dextran or cyclodextrins with various benzyloxybenzoic acids (BBA) through esterification. In a typical procedure, a BBA was coupled to dextran or cyclodextrins using the coupling reagent diisopropylcarbodiimide (DIC) with dimethylaminopyridine (DMAP) as nucleophilic catalyst, and the reaction was performed in 3:1 dimethylsulfoxide (DMSO)/dichloromethane (DCM) for 72 hours. The resulting polymer conjugate was precipitated in 0.15 M HCl (aq.), and the product was isolated by centrifugation. The benzyl protecting groups (masking the phenolic —OH groups) were removed under an atmosphere of H₂ using a palladium catalyst in dimethylformamide (DMF). The catalyst was filtered from the reaction mixture, and the solvent was removed by rotary evaporation. The resulting polyphenol (i.e., polymer conjugate) was dissolved in 0.7M Na₂CO₃ (aq.) with 10 mM sodium ascorbate, purified by dialysis, flash frozen in liquid nitrogen and freeze dried.

Polymer conjugates with gallol, catechol, or resorcinol pendant side groups were synthesized. The benzyl protected precursors to these pendant side groups were 3,4,5-tris(benzyloxy)benzoic acid (TBBA), 3,4-bis(benzyloxy)benzoic acid (34BBA), and 3,5-bis(benzyloxybenzoic acid (35BBA), respectively. To conjugate the BBAs to the polysaccharide scaffold, an inventive synthetic method was developed based on a modified Steglich reaction (Neises et al. 1978 Angewandte Chemie-International Edition in English, 17: 522-524). The reaction generally includes four components: an alcohol, a carboxyl, a carbodiimide, and an acyl transfer agent catalyst. In the present example, these components were, respectively, a polysaccharide, a BBA, DIC, and DMAP. Performing the reaction essentially homogeneously (i.e., in solution) and with the starting materials and reagents at high concentrations was found to be advantageous in the present Example for achieving a substantially high degree of conjugation.

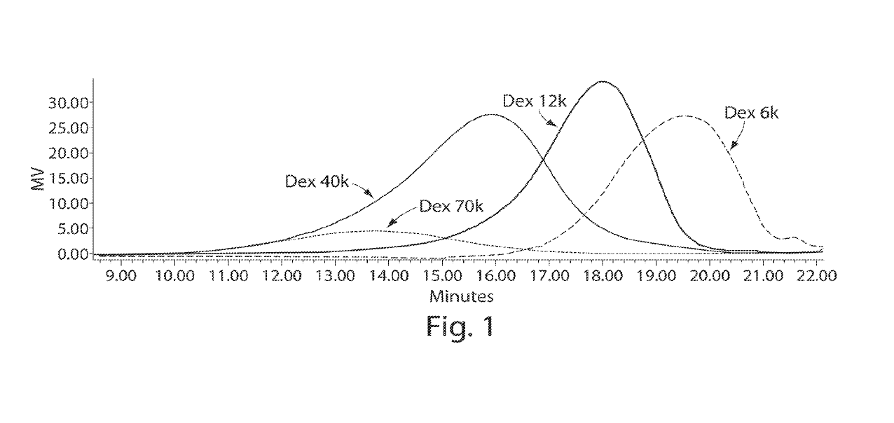

Dextran was substantially insoluble in most solvents tested, with the exception of a few polar solvents including water, DMSO, formamide, and N-methyl-2-pyrrolidone. Since the esterifications benefit from use of non-polar solvents, gel permeation chromatography (GPC) was used to screen a series of non-polar co-solvents that could be added to drive the reaction forward. The solvent used for GPC studies was tetrahydrofuran (THF), in which dextran has limited solubility. As the reaction proceeded, the Dextran-BBA conjugates became more soluble in THF and therefore eluted from the GPC column (FIG. 1). Anisole, THF, DCM, CHCl₃, CCl₄, EtOAc, and 1,4-dioxane were evaluated as co-solvents in a 3:1 ratio with DMSO. Of these co-solvents, only DCM resulted in elutable polymer. Under these conditions, DMSO alone did not dissolve the entire amount of DMAP used.

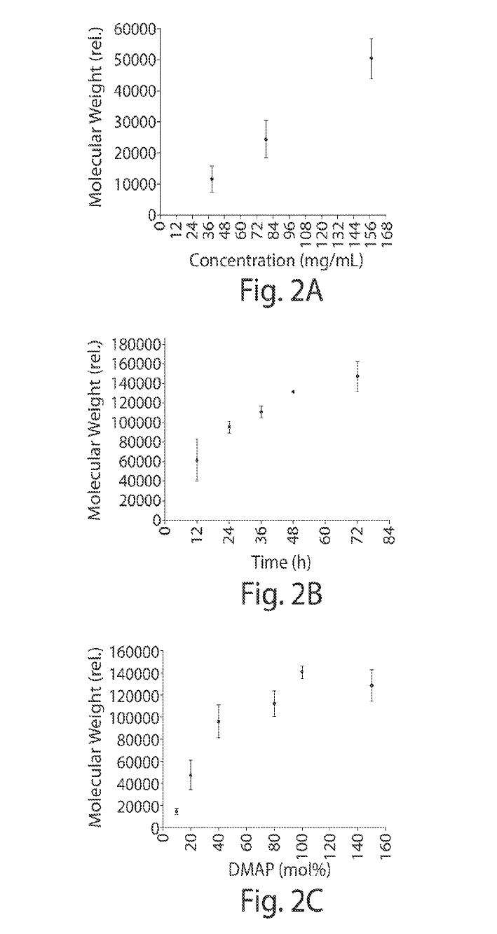

The reaction kinetics of dextran (MWₐᵥₑ=70 kDa) esterification with TBBA were studied using GPC. The polymers reached a peak size after 48 hours of reaction time. The molecular also increased with the amount of DMAP used, up to 100 mol % relative to the amount of dextran, and the total reaction concentration (FIG. 2). When 3-10 mol % DMAP was used, a precipitate formed in the reaction after 1-2 hours.

After synthesizing PBBAs, the resulting polyphenols were obtained by cleaving the protecting groups using a palladium catalyst in the presence of hydrogen. The polymer was first extracted out and dissolved in a compatible solvent for deprotection. DMSO and the DMAP were removed prior to deprotection. Extracting the insoluble PBBA in aqueous 0.15M HCl three times generally resulted in complete removal of both DMSO and DMAP as confirmed by ¹H NMR.

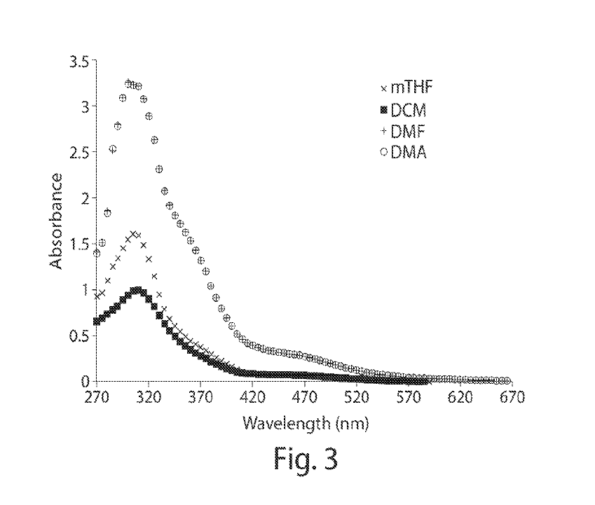

A series of solvents, Pd catalysts, and hydrogen sources were evaluated to optimize deprotection. Polar, protic solvents are generally best for Pd catalyzed debenzylation. However, because of the poor solubility of PBBAs in these solvents, DCM, mTHF, DMF and dimethylacetamide (DMA) were evaluated as deprotection solvents, and a browning assay was used to determine their efficacy. The polymers resulting from each were dissolved in water and then filtered, dialyzed, and freeze dried. Then, all were dissolved in water at a constant concentration. 1M NaOH was added to oxidize the polyphenols. A visible color change occurs as the phenols first oxidize and then crosslink into melanins, which absorb broadly in the visible spectrum. More browning was interpreted as a higher phenolic content. DMF and DMA both resulted in most browning (FIG. 3). However, DMA was more difficult to remove via dialysis.

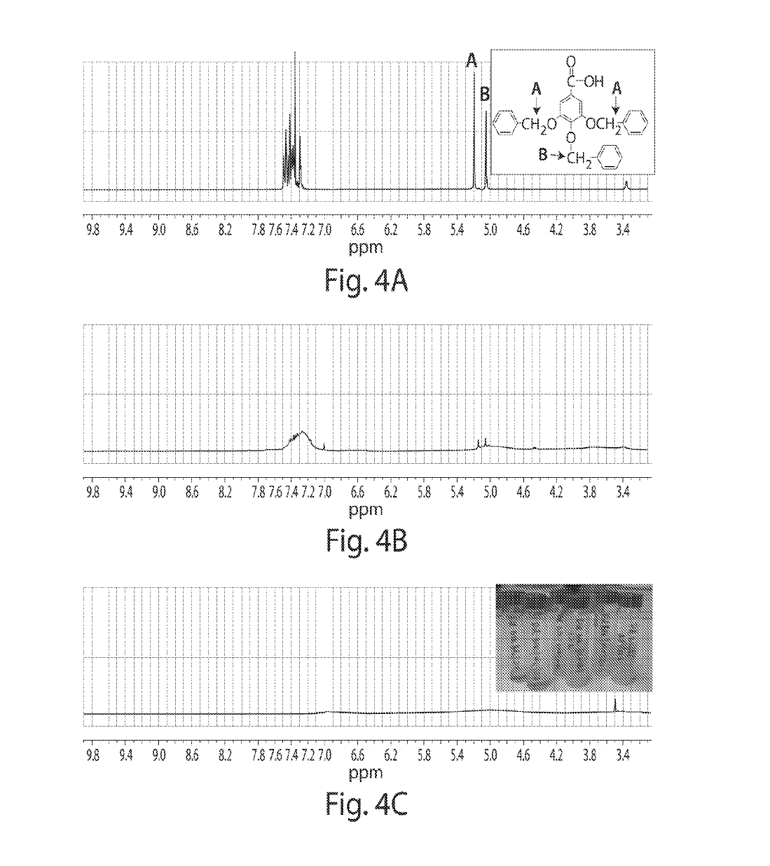

Initially, deprotection schemes were screened for their ability to generate water soluble polymers. Then ¹H NMR was used to check for remaining protecting groups. The best catalysts were, in order, Pd black>30 wt % Pd/C>10 wt % Pd/C. The remaining benzyloxy groups have chemical peaks at 5.0 and 5.1 ppm (FIG. 4). Full deprotection was generally achieved using 1:1 ratio of protecting group to catalyst.

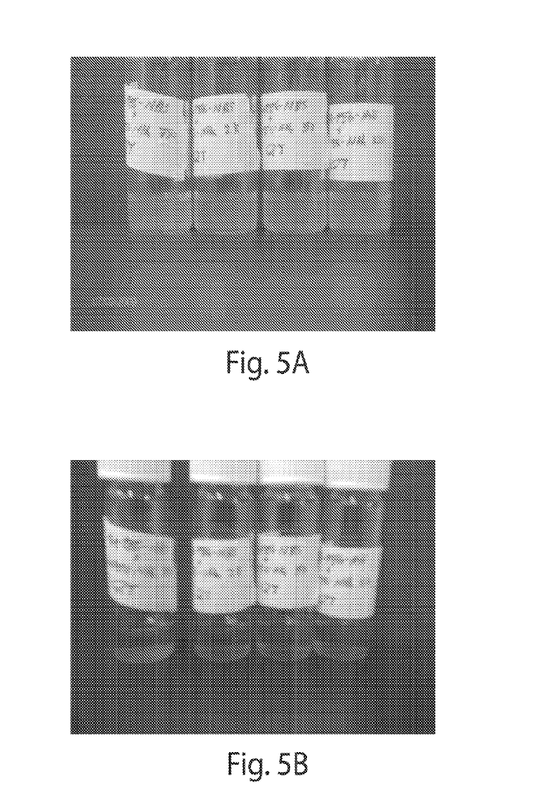

The polyphenols obtained after deprotection were substantially insoluble in water. A concentrated carbonate buffer was chosen for its ability to fully dissolve the product but not induce browning. Sodium hydroxide, even at dilute concentrations, caused immediately visible browning. Browning occurred in carbonate buffer but much more slowly and could be prevented by adding a suitable reducing agent. A number of antioxidants/reducing agents were screened for their ability to prevent the oxidation of quebracho tannin solutions in water, which happens quickly in air. By consuming the phenolic moieties, this reaction also disrupts polycomplexation. As shown in FIG. 5, Quebracho tannin/PEG suspensions were visibly browner and less turbid after one day in the absence of an antioxidant. A series of antioxidants were investigated to prevent browning that included vitamin C, isoascorbic acid, sodium dithionite, sodium bisulfate, and glutathione. Both vitamin C and sodium dithionite were the two best candidates and were equally effective at preventing browning. Vitamin C was chosen because of its low toxicity.

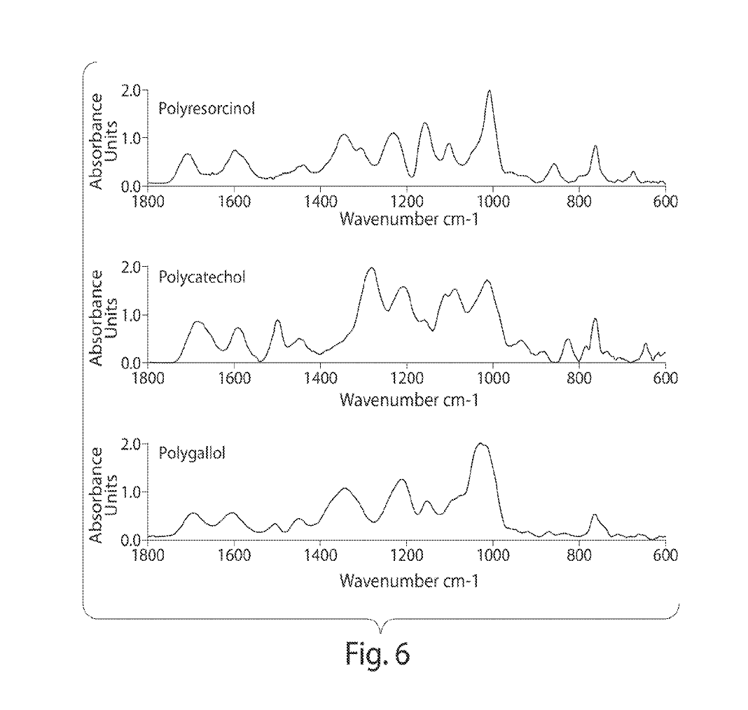

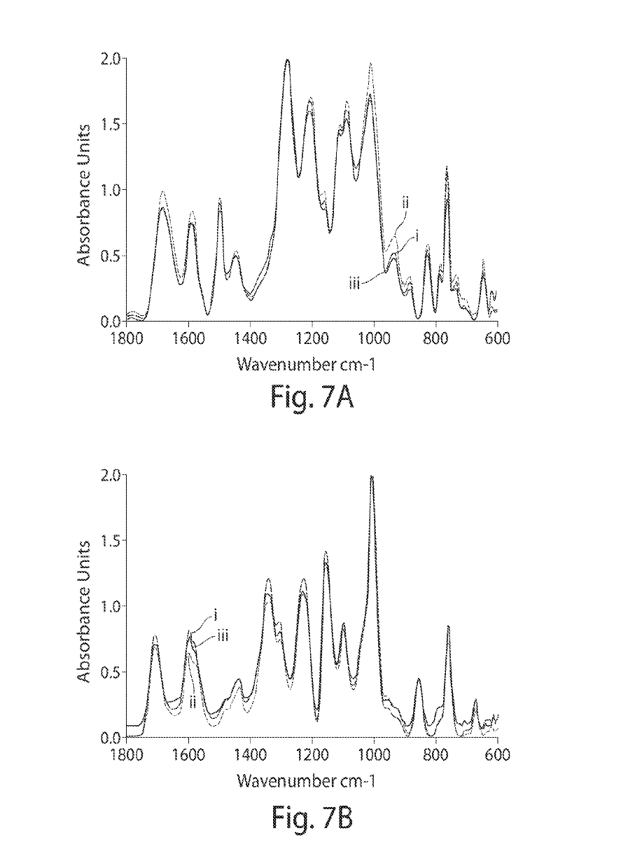

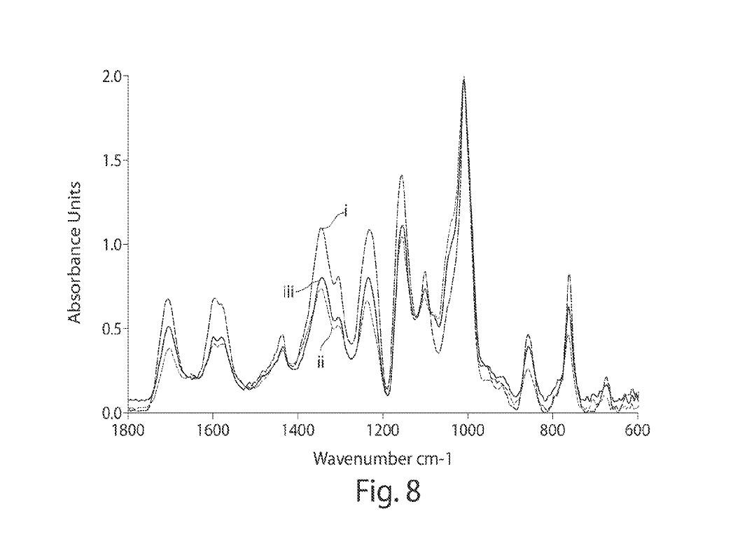

The infrared absorbance spectra were acquired for dry polyphenoxide sodium salts using attenuated total reflectance (FIG. 6). Each of the three types of polymer showed an absorbance between 1701-1685 cm⁻¹ from the carbonyl groups introduced during esterification. The peaks from 1605-1450 cm⁻¹ were attributed to aromatic ring C═C vibrations. Each type of polyphenol had a unique series of absorbance bands due to C—O stretching from 1345-1010 cm⁻¹. The C—O absorbance bands for the phenoxide moieties are known to shift to slightly higher wavenumbers than for their corresponding phenols (Kotorlenko et al. 1984 Journal of Molecular Structure, 115: 501-504). The reaction appears to be independent of the dextran scaffold molecule weight. FIG. 7 shows overlayed spectra that are nearly identical for polyresorcinols or polycatechols synthesized across a range of scaffold molecular weights. The amount of dextran used in the esterification was varied in order to change the ratio of hydroxyls to carboxyls. As the ratio decreased, the absorbance shoulder at 1050 cm⁻¹ generally decreased relative to the band from 1030-1010 cm⁻¹ (FIG. 8). The deconvoluted FTIR spectrum for dextran contains two bands region which correspond to ordered and amorphous chain configurations (Shingel 2002 Carbohydrate Research, 337: 1445-1451). Without wishing to be bound by any theory, this type of relative reduction in absorbance at 1050 cm⁻¹ is believed to be caused by a decrease in intramolecular hydrogen bonding, which is expected to occur as more hydroxyls are substituted during esterification. Bands in the range 900-600 cm⁻¹ were attributed to aromatic C—H out of plane (oop) bending. A more detailed peak assignment is shown in Table 1.

TABLE 1
Peak infrared absorbance bands (cm⁻¹) synthetic polyphenols
between 1800-600 cm⁻¹.

| Assignment | Polycatechol | Polygallol | Polyresorcinol |
|---|---|---|---|
| C═O (ester) | 1690 | 1696 | 1710 |
| C═C stretch | 1596 | 1605 | 1599 |
| (aromatic) | 1499 | 1505 | 1440 |
| | 1451 | 1450 | |
| C—O stretch/bend | 1282 | 1345 | 1346 |
| | 1208 | 1212 | 1308 |
| | 1160 | 1154 | 1232 |
| | 1112 | 1031 | 1158 |
| | 1090 | | 1102 |
| | 1014 | | 1009 |
| C—H oop (aromatic) | 884 | 860 | 871 |
| | 827 | 763 | 837 |
| | 785 | 675 | 766 |
| | 764 | | |
| | 737 | | |
| | 709 | | |

### Example 2

This example demonstrates formation of inventive self-assembled structures comprising polymer conjugates of the invention.

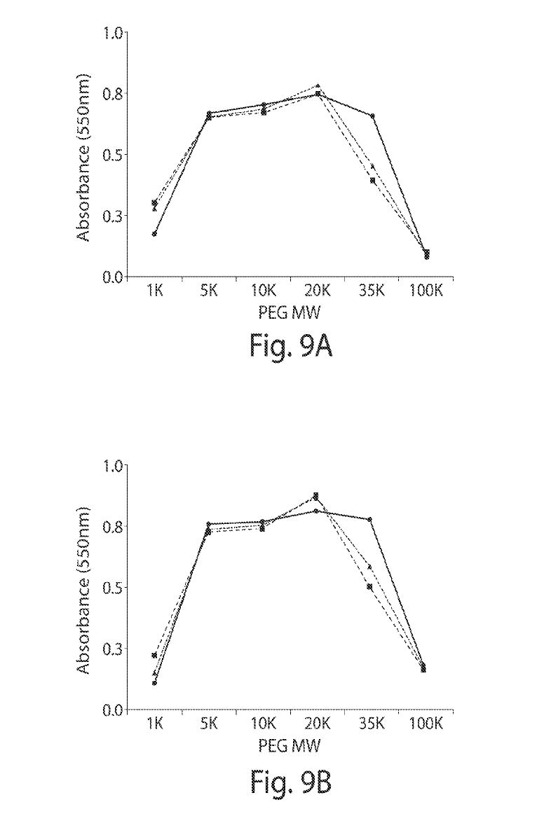

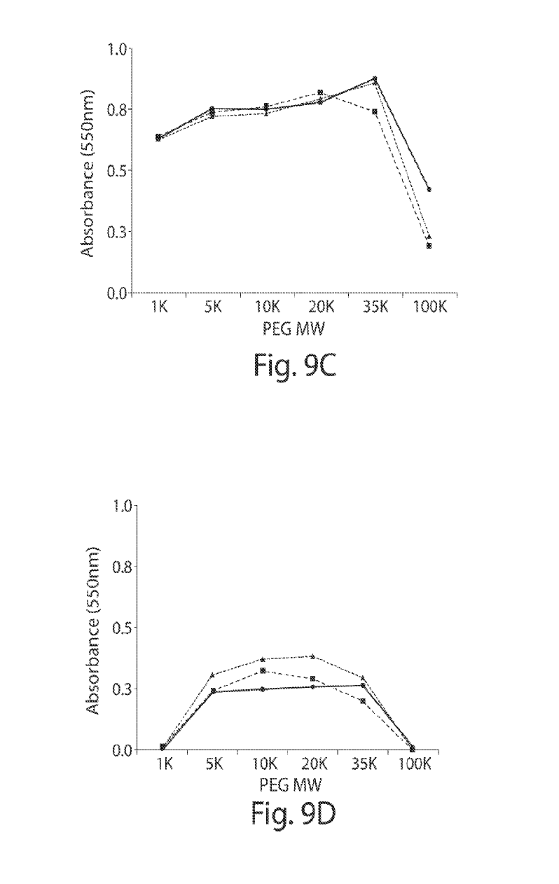

In their polyphenoxide form, all polymer conjugates from Example 1 were water soluble. However, at a pH below −8 they generally precipitated from solution. Complexation was induced by mixing aqueous solutions of PEGs and polyphenols in 90% of the desired solvent volume. A 10× phosphate buffered saline (PBS) concentrate was then added up to the final volume to induce complexation. Turbidity was analyzed with UV/VIS spectroscopy by measuring absorbance at 550 nm. The stability of polycomplexes is known to depend on the molecular weight of the polymer (Papisov et al. 1971 Doklady Akademii Nauk Sssr, 199: 1364-&; Baranovsky et al. 1981 European Polymer Journal, 17: 969-979). Without wishing to be bound by any theory, it is believed that the matrix will also ‘recognize’ or prefer polymers with certain chain lengths when exposed to a mixture of chain lengths. The turbidity of several polyphenols mixed with commercially available PEGs of various sizes was measured. Plots of the stability of these polycomplexes, as indicated by increased turbidity, versus PEG chain length typically had an initial sigmoidal appearance that fit well with theory (FIGS. 9A-9D). However, the turbidity sharply declined above a certain PEG chain length. This phenomenon was independent of the PEG/polyphenol mass ratio in the mixture. Turbidity was influenced by varying the OH/COOH ratio during esterification (FIG. 9B and FIG. 9C). Without wishing to be bound by any theory, it is believed that at higher ratios the polyphenol should be less substituted and therefore form weaker complexes.

When viewed under a microscope, the polycomplexes with the lowest PEG molecular weights either showed diffuse precipitate or spherical microstructures. These spherical microstructures appeared smaller as the PEG length increased. At higher chain lengths some samples contained no visible particulates when under the microscope. These mixtures typically contained stable, nanoscale colloids. Mixtures that had no detectable turbidity and appeared visibly clear generally possessed the smallest nanostructures.

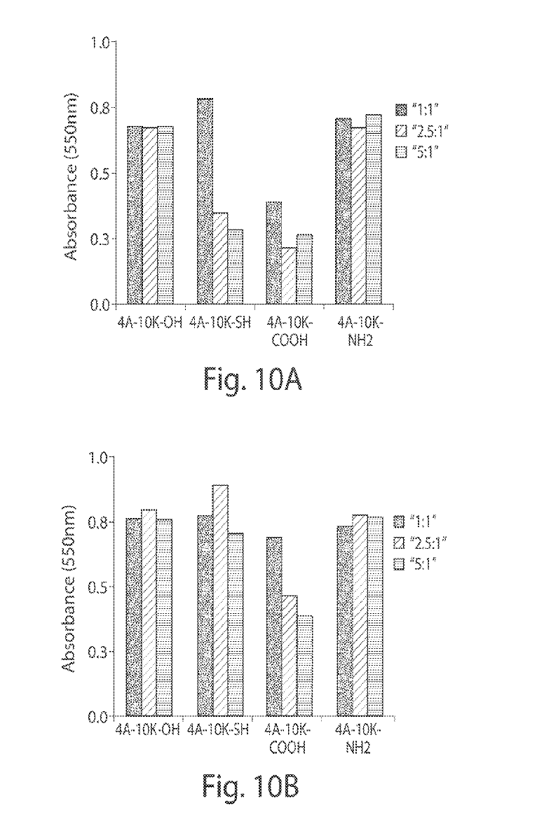

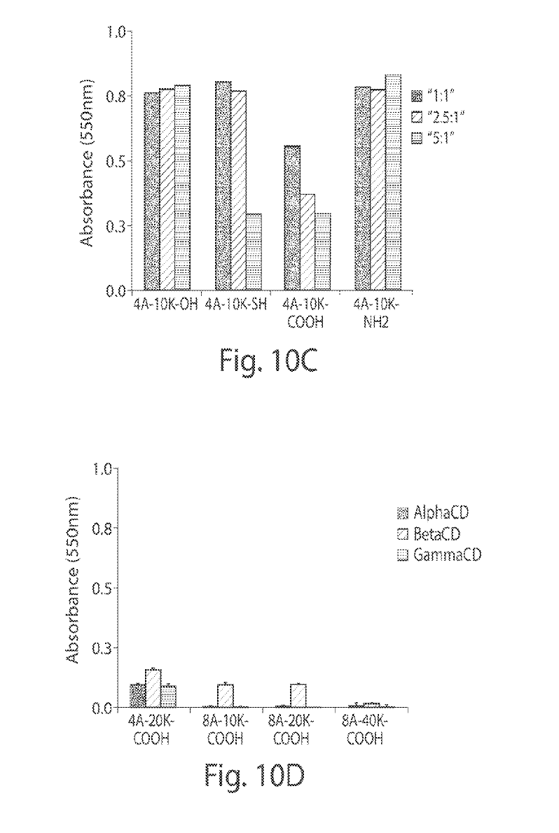

Polycomplex stability and size also depend on the configuration of the complimentary polymers and chain substitutions. Mixtures of polyphenols with multi-arm star-shaped PEGs of various sizes and with different terminal functional groups were evaluated. Polycatechols formed visibly different complexes when mixed with star-shaped PEGs that differed only in end groups. Turbidity generally decreased for complexes formed with thiol and carboxy terminated PEG for mixtures with PEG/polyphenol mass ratios above 1 (FIG. 10A-10D). The effect of PEG size and branching was further evaluated using a selection of star-shaped PEGs with carboxy termini (FIG. 10D). These mixtures generally had undetectable or low turbidity but all contained nanoparticles that could be measured using dynamic light scattering (Table 2). These data showed that by using commercially available PEGs with branched architecture and various functional groups, self-assembled nanoparticles small enough for mammalian cell endocytosis can be generated (Goldberg et al. 2007 J Biomater Sci Polym Ed, 18: 241-68).

TABLE 2
Average hydrodynamic diameters of polycomplexes
formed from mixtures of carboxy terminated star-shaped
PEGs and polycatechols derived from cyclodextrins
(cyclocatechols). The mass ratio of
PEG to polyphenol was 5:1 in all groups.

| | Hydrodynamic diameter (nm) | | | |
|---|---|---|---|---|
| | 4A-20K- | 8A-10K- | 8A-20K- | 8A-40K- |
| Cyclocatechol | COOH | COOH | COOH | COOH |
| α | 171 | 165 | 145 | 92 |
| β | 192 | 261 | 192 | 108 |
| γ | 198 | 177 | 141 | 103 |

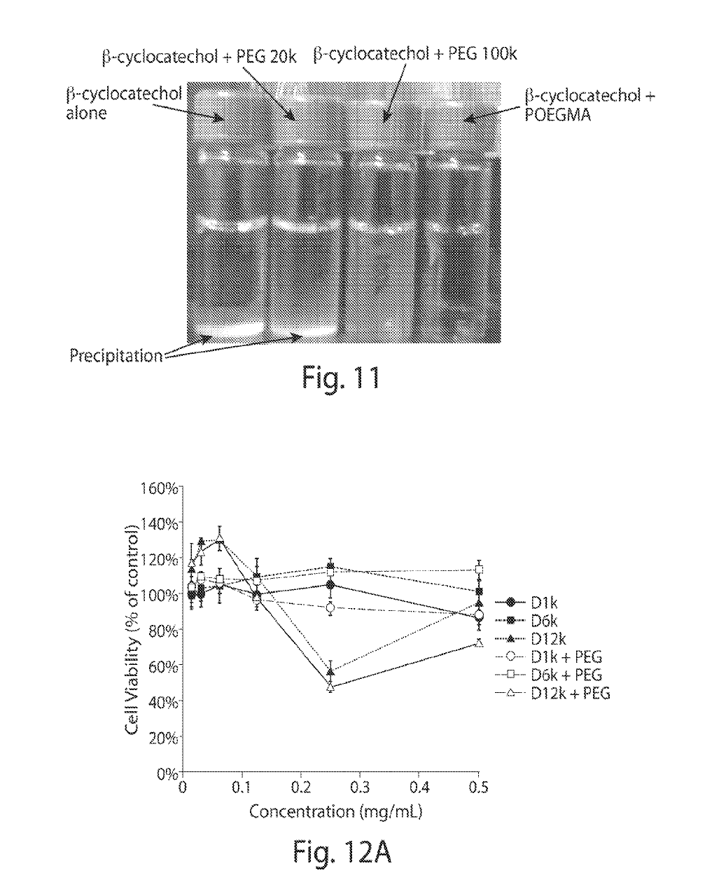

Comb-shaped PEG-like polymers of well defined molecular weight were also synthesized using atom transfer radical polymerization (ATRP) (Tugulu et al. 2005 Biomacromolecules, 6: 1602-1607). These poly[oligo(ethylene glycol)methacrylate] (POEGMAs) included a linear polymethacrylate backbone grafted with PEG chains of discrete length. By synthesizing these, H-bonding partners with higher degrees of branching than what is commercially available could be generated. Mixtures of a polycatechol alone, with 20 kDa and 100 kDa, and with one POEGMA are shown in FIG. 11. The POEGMA used has a molecular weight of 55,350 Da. The degree of polymerization was 150 and the PEG side chain was 300 Da. The mixture appeared visibly clear but contained nanoparticles that were 67 nm in diameter.

### Example 3

This example demonstrates the biocompatibility of certain polymer conjugates of the invention.

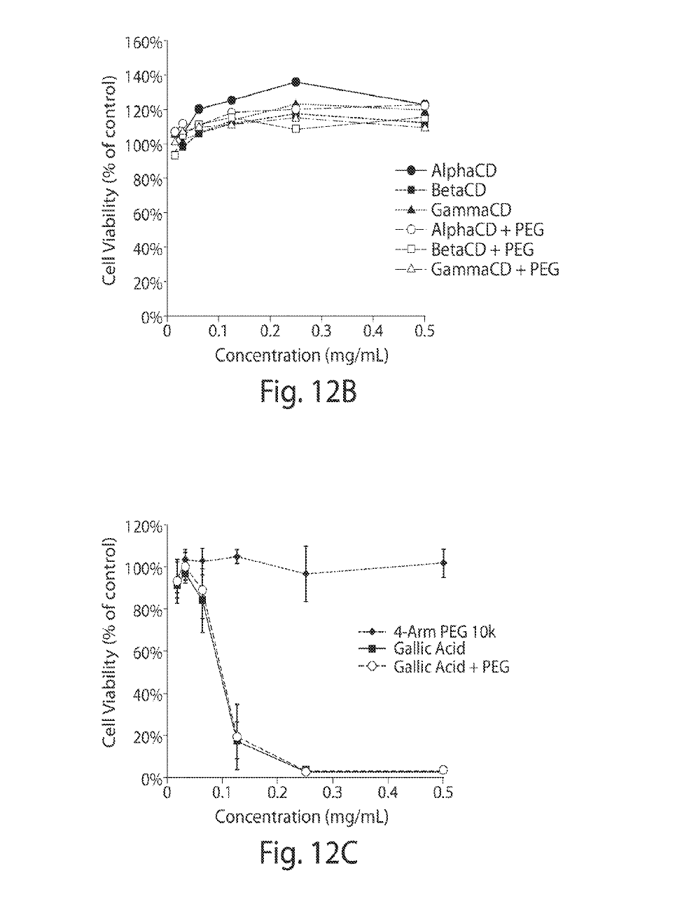

The cytotoxicity of a selection of polycatechols, made as described in Example 1, in contact with HeLa cells was assessed (FIG. 12). Gallic acid, which is known to be cytotoxic in vitro was used as a positive control. Cell viability was assessed using an MTS assay (Promega). Both polyphenols alone and polycomplexes were exposed to cells over a range of concentrations and allowed to incubate for 24 hours. The polycomplexes were formed using a 4-arm PEG of 10 kDa. Only the largest polyphenol, made using a dextran scaffold of 12 kDa, was found to affect cell viability. All others were non-toxic over the concentrations tested. None were as cytotoxic as gallic acid.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A composition, comprising:
a polysaccharide comprising a plurality of covalently bound pendant side groups, wherein each of the plurality of pendant side groups comprises a structure as in formula (II): 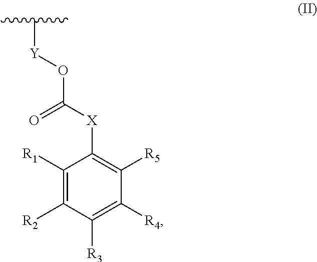
wherein:
“ [symbol] ” comprises a polymer;
at least three of R₁, R₂, R₃, R₄, and R₅ is a hydroxyl group or a substituted derivative thereof and the remainder of R₁, R₂, R₃, R₄, and R₅ are each independently hydrogen or substituted;
X and Y each comprise, independently, a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; or a salt thereof.

2. The composition of claim 1, wherein the polysaccharide is cyclic.

3. The composition of claim 2, wherein the polysaccharide is cyclodextrin.

4. The composition of claim 2, wherein the polysaccharide is linear.

5. The composition of claim 4, wherein the polysaccharide is dextran.

6. The composition of claim 1, wherein X is a bond.

7. The composition of claim 1, wherein Y is a bond.

8. The composition of claim 1, wherein R₂ and R₃ are each, independently, a hydroxyl group or substituted derivative thereof.

9. The composition of claim 1, wherein R₂ and R₄ are each, independently, a hydroxyl group or substituted derivative thereof.

10. The composition of claim 1, wherein R₂, R₃, and R₄ are each, independently, a hydroxyl group or substituted derivative thereof.

11. The composition of claim 1, further comprising a pharmaceutically acceptable carrier.

12. The composition of claim 1, wherein the substituted derivative is a benzyloxy group.

13. The composition of claim 1, further comprising a complexing agent.

14. The composition of claim 13, wherein the complexing agent is a polymeric Lewis acid.

15. The composition of claim 1, wherein the polysaccharide comprises at least 5 saccharide units.

16. The composition of claim 1, wherein the polysaccharide comprises at least 20 saccharide units.

17. The composition of claim 1, wherein the polysaccharide comprising a plurality of covalently bound pendant side groups has a degree of substitution between 20% and 80%

18. A composition, comprising:
a polymer comprising a plurality of covalently bound pendant side groups, wherein each of the plurality of pendant side groups comprises a structure as in formula (III): 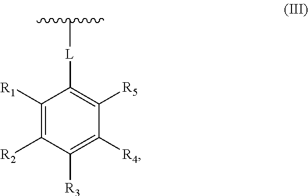
wherein:
“ [symbol] ” comprises a polymer;
at least one of R₁, R₂, R₃, R₄, and R₅ is a substituted hydroxyl group, the substituted hydroxyl group not being a methoxy group, and the remainder of R₁, R₂, R₃, R₄, and R₅ are each independently hydrogen or substituted;
L comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; and/or at least one covalent linkage group.

19. The composition of claim 18, wherein the substituted hydroxyl group is a benzyloxy group.

20-49. (canceled)

50. A composition, comprising:
a polymeric Lewis base; and
a self-assembled structure comprising a polymer having a plurality of covalently bound pendant side groups, wherein each of the plurality of pendant side groups comprises a structure as in formula (III): 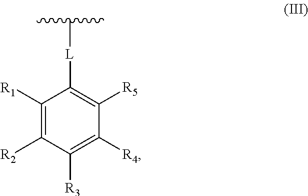
wherein:
“ [symbol] ” comprises a polymer;
at least one of R₁, R₂, R₃, R₄, and R₅ is a hydroxyl group or a substituted derivative thereof and the remainder of R₁, R₂, R₃, R₄, and R₅ are each independently hydrogen or substituted;
L comprises a bond; a substituted or unsubstituted, branched or unbranched, cyclic or acyclic C₁₋₃₀ aliphatic; a substituted or unsubstituted, branched or unbranched, cyclic or acyclic C₁₋₃₀ heteroaliphatic; substituted or unsubstituted aryl; or a substituted or unsubstituted heteroaryl; and/or at least one covalent linkage group; or a salt thereof.

51-112. (canceled)
